(19) United States
(12) Patent Application Publication
(10) Pub. No.: US 2006/0041848 A1
(43) Pub. Date: Feb. 23, 2006

(54) Overlaid display of messages in the user interface of instant messaging and other digital communication services

(76) Inventor: Luigi Lira, Costa Mesa, CA (US)

Correspondence Address: GLENN PATENT GROUP, 3475 EDISON WAY, SUITE L, MENLO PARK, CA, 94025, US

(21) Appl. No.: 11/137,174

(22) Filed: May 24, 2005

Related U.S. Application Data
(60) Provisional application No. 60/603,714, filed on Aug. 23, 2004.
(60) Provisional application No. 60/609,079, filed on Sep. 10, 2004.
(60) Provisional application No. 60/648,925, filed on Feb. 1, 2005.

(51) Int. Cl. G06F 17/00

(52) U.S. Cl. 715/805

(57) ABSTRACT

The invention relates to instant messaging communications, and more particularly to overlaid messages, e.g. texts, graphics, images, animations, movies, or any combination of them, with or without sounds, that are delivered from a sender's instant message client to at least one recipient's instant message client. Typically, such overlaid messages are displayed for a brief period of time and often overlaid on the session window, or on any chosen area of the client system screen, and may be displayed for longer time in the transcript of the communications usually small-sized or, for example, otherwise transformed, represented, or indicated.

### CROSS REFERENCE TO RELATED APPLICATIONS

This application claims priority to U.S. provisional patent application Ser. No. 60/603,714, filed 23 Aug. 2004, 60/609,079, filed 10 Sep. 2004, and 60/648,925, filed 01 Feb. 2005, which applications are incorporated herein in their entirety by this reference thereto.

This application also incorporates herein in its entirety by this reference thereto disclosure document no. 556,080, which was received at the U.S. Patent Office on 30 Jun. 2004, disclosure document no. 572,718, which was received at the U.S. Patent Office on 17 Mar. 2005, and disclosure document no. 572,867, which was received at the U.S. Patent Office on 17 Mar. 2005.

### BACKGROUND OF THE INVENTION

1. Technical Field

The invention relates to instant messaging communications. More particularly, the invention relates to overlaid messages, e.g. texts, graphics, images, animations, movies, or any combination of them, with or without sounds, delivered from a sender's instant message client to at least one recipient's instant message client. Typically, such overlaid messages are displayed for a brief period of time and are often overlaid on a session window, or on any chosen area of a client system screen. Such messages may be displayed for a longer time in a transcript of a communications session, usually small-sized or, for example, otherwise transformed, represented, or indicated.

2. Description of the Prior Art

An instant message (IM) is a form of electronic communication between users of a computer network in which a message is delivered instantly and without the recipient having to access an e-mail program or otherwise check for messages. An instant message appears essentially as soon as the message sender clicks the send button, subject to any time or propagation delays the message may have encountered on the network. In comparison to most e-mail applications, instant messaging enables users to communicate with each other in a more dynamic, interactive, and entertaining manner.

FIG. 4A shows a simplified session window 100 that contains the user interface basic elements. These basic elements are featured in the user interface of the major IM services, such as those from America Online, Inc., Yahoo, Inc., and Microsoft, Inc. The basic elements of the user interface are a transcript area 101 where the messages from all the users involved in the communication are displayed in their chronological order as they are sent; a message composition area 102 where the user inputs the message to send to the other parties involved in the communication; and a send button 103 that the user selects when ready to send the message. Typically, the user interface also contains many other elements, for example, a control to select the font of the message, a control to select the font size of the message, and a control to select the color of the message text, among others. Those extra elements are not relevant for the herein description.

For the purpose of illustrating an IM communication, FIG. 4B shows a session window 100 where two users have exchanged a few messages. The message address field 111 shows which user sent the message. The currently available IM services are able to send text content 112 formatted with font, size, color, and other attributes chosen by the sender. They are also able to send emoticon graphic content 113. So-called emoticons are small to medium sized images or graphics, typically depicting cartoon-like smiling, winking, or sad faces. Emoticons are generally provided by the IM service itself, and are accessible to the sender by means of a user interface element, for example, a pop-up or a sub window. The currently available IM services are also able to send image content 114. The image is usually not provided by the service. The sender typically supplies it. In addition, currently available IM services are able to send data files that, being raw data, can contain any media and information.

FIG. 4C shows a more sophisticated session window 100 that contains two types of recently introduced user interface elements. The user interface elements are referred to as wallpapers 116a and 116b and avatars 117a and 117b. Both are described as user personalization items meant to enhance the user projected presence and personality. Both wallpapers and avatars are typically chosen by the sender on a per session or default basis and are typically displayed symmetrically, i.e. showing the same content at, or almost at, the same time, on both the sender's and recipient's client user interfaces for the whole length of the session. The avatar typically resembles a cartoon-like head of a fictional character, and it may be animated upon sender's input or autonomously upon input from the communication itself. In addition, during the animation they may rest, or they may move within the session window. Both wallpapers and avatars are persistent and are meant to enhance the entertainment of the communication by means of a persistent fictional projection, also called a proxy representation, of the sender on the recipient's client user interface.

FIG. 4D shows an example of a greeting card 119 displayed within a browser window 210 separated from the recipient's instant message window 100. Essentially, the instant message client issues a request to an Internet browser, e.g. Internet Explorer, to load and display a web page containing the greeting card. This prior art has several disadvantages. To name a few:

The greetings card is displayed within a separate window of an Internet browser, e.g. Internet Explorer. Such window is typically either placed centered on the screen or placed near the session window 100; only accidentally, i.e. unintentionally, such window may overlay the session window 100.

Greetings card technology does not allow the sender to supply the text for the greetings card from within the composition area 102, does not allows the sender to specify the request to send a greetings card by typing text in the composition area 102, and does not allows the sender to specify the parameters for a greetings card by typing text in the composition area 102. This limitation result in the fact that it requires several tens of seconds for a sender to select and edit a greeting card, making greetings cards unsuitable for frequent use in a communication. Typically greetings cards are exchanged once in a communication session if any. The large majority of the users do not send greetings cards more often than once a month.

Greeting cards are essentially all of the same size, preventing the sender from using the size as a mean of expression, e.g. small is “discreet” and large is “loud”. Greeting cards have no parameters, and the sender cannot select its size, position, transparency, etc.

Greeting cards do not support artistic rendering of sender supplied text, e.g. an “electric” effect, a “glowing” effect, a “3D” effect. Even though some greetings card may comprise some graphically integrated text, such text is part of the greetings card and it is unmodifiable. Greetings card technology allows for the sender to supply text, but greetings card technology currently on the market display such text small, static, monochromatic, having peripheral placement in relation to the greetings card, and without animation; being such user supplied text mostly in the role of caption to such greeting card

Greeting cards do not implement parametric recipient side graphic processing on the greeting card components, e.g. texts, artworks, and animations. A parametric recipient side graphic processing is a graphic processing that the sender can select to be performed by the recipient's client on the greeting card components before the greeting card is displayed to the recipient. The lack of parametric recipient side graphic processing prevents the embodiment from allowing the sender to select a variety of different options for the same basic greeting card, e.g. a larger version, a version with artworks rendered in 3D, a version with text “burning in flames”. Supporting a selection from a large amount of variation without implementing parametric recipient side graphic processing would require the recipient's client to receive a new greeting card each time, instead of reusing an already received one with a different graphic processing applied on it, resulting in large bandwidth requirements and poor caching performance.

Due to the many limitations, prior arts are not suitable to deliver intense and instantaneous “emotional” expressions such as a sudden joy or sadness, a felt approval or disapproval, or a strong reply. Nor are suitable for frequent use without placing an heavy load on the instant message host system.

In an informal IM conversation, the entertaining aspect of the communication is important. Often the entertainment is the actual reason for the conversation itself. The informal IM conversation accounts for a large portion of the IM sessions and counts substantially toward the use and popularity of a particular IM service. To exemplify the importance of the entertaining aspect of the communication, the introduction in IM services of a simple innovation that enhanced the entertaining aspect of the communication created a buzz in the IM user community. It also created a competitive advantage for the first IM service provider that supported it. All other service providers rapidly imitated the innovation. Such innovation was related to emoticons. Emoticons were used to be displayed as sequence of characters, for example, a :-) to represent a smiley face or a :-( to represent a sad face. The innovation was to render such emoticons as small graphics showing cartoon-like smiling faces or cartoon-like sad faces.

Prior art instant messaging embodiments have the capability to deliver from a sender's client to at least one recipient's client large-sized artworks and/or large sized texts, and to display them. Artworks are, for example, texts, graphics, images, animations, movies, or any combination of them, with or without sounds. However, prior art instant messaging embodiments constrain the artwork and/or text display within the boundaries of the transcript area, and constrain the artwork and/or text display to its proper transcript-sequence position, e.g. the artwork and/or text of message 3 is displayed under the artwork and/or text of message 2 that, in turn, is displayed under the artwork and/or text of message 1. The disadvantages of such an approach are several. To name a few:

It requires the recipient to maintain a large-sized session window for the sole purpose of viewing the large-sized artworks and/or texts, using screen space that is otherwise used for other session windows or windows from other applications.

Even with large-sized session windows, the emotional impact delivered by the artwork and/or text is not at its best because its placement is not optimal, e.g. the displayed artwork and/or text does not stand out from the surrounding user interface because, for example, other items distract from the displayed artwork, or the displayed artwork is out of the user's best visual region of focus. It is easy to understand that this limitation applies to large-sized, medium-sized, and small-sized artworks and/or texts.

If the artwork and/or text is animated, it can move, e.g. reposition itself, only within the area used to display the artwork and/or text themselves, that is smaller than, or up to the size of, the session window. This limitation applies to large-sized, medium-sized, and small-sized artworks and/or texts.

The artwork and/or text cannot be integrated. The sender does not have the option to closely associate text to the artwork to enhance the impact of the message he is trying to convey to the recipient. The sender can only add text before or after the artwork.

The area used to display the artwork and/or text is fixed in size. Consequently, a large-sized artwork and/or text uses a large portion of the transcript area, i.e. the visible part of the transcript, shifting the previous messages considerably up in the transcript and often out of the transcript area. Both large-sized and medium-sized artworks and/or texts clutter the transcript.

Often a user has several active IM sessions at once, i.e. communications with buddies and other users. When the user's attention goes back to the IM session from other tasks, the cluttering of the transcript prevents the user from quickly re-reading, or at least glimpsing through, the last few messages of the session, thus preventing the user from instantly recalling the point of communication. This limitation happens with both large-sized and medium-sized artworks and/or texts.

Not all of the IM user demographics find it useful or appealing to send or receive large-sized artworks and/or texts, or any kind of artworks for that matter. For example, lawyers, engineers, or financial operators usually find little or no appeal in sending or receiving artworks, being more interested in the actual content of the communication than in the entertainment of it. Though, several other demographics, actually representing today's majority of the IM users, do find it appealing to send or receive artworks. For example, kids, teenagers, and students like or even love to send artworks, especially large-sized ones, if they are enabled to do so quickly, easily, and unobtrusively, such users prizing, in a communication, its entertainment aspect as much as its content.

### SUMMARY OF THE INVENTION

The herein specified invention start from the idea to make a communication more entertaining by means of magnifying and overlaying messages themselves. Once a message is magnified, its liveliness can be enhanced by means of colors, styles, animations, and artworks.

The herein described invention recognizes the prior art instant messaging embodiment limitations and introduces a solution to those limitations. It does so by separating the display of the artwork and/or text in two distinct temporal stages herein called “presentation” and “reminder.” The presentation stage is substantially transient; the reminder is substantially persistent. Additionally, it allows the sender to integrate the text with the artwork to create a more effective message.

For the preferred embodiment, during the transient presentation stage, the artwork and/or text is typically displayed, e.g. displayed, played, made visible, or otherwise enabled to be perceived, for a brief period of time and is often overlaid on any chosen area of the recipient's client system screen. More specifically, the transient presentation is often set to overlay the recipient's session window itself. During the optional persistent reminder stage that lasts for the session duration, the artwork and/or text, or an alternative for them, is inserted, usually small-sized, in the transcript, as a reminder to the users. The herein disclosed invention overcomes the disadvantages of the prior art instant messaging embodiments. To name a few of the disadvantages that are overcome by the invention:

It does not require the user to maintain a large-sized session window to view large-sized artworks and/or texts. The artwork and/or text is presented without regard to the boundaries of the transcript area.

The emotional impact delivered by the artwork and/or text is at its best because its placement is optimal. The placement is not constrained by the boundaries of the transcript area. In addition, because the presentation remains in place only for a brief period of time, the surrounding user interface can be, for example, safely obscured, dimmed, or cleared so as not to distract from the artwork and/or text. This is an advantage for large-sized, medium-sized, and small-sized artworks and/or texts.

If the artwork and/or text is animated, it can move, e.g. reposition itself, within the whole screen. This is an advantage for large-sized, medium-sized, and small-sized artworks and/or texts.

The sender can integrate text with the artwork to, for example, explain, clarify, or add irony to the message he is trying to convey to the recipient. The artwork and the integrated text, when combined, produce an emotional impact far superior than the sum of individual parts alone.

The area used by the artwork and/or text is not fixed in size. The presentation, even if large-sized, is transient. The reminder is small-sized and does not clutter the transcript. This is an advantage for both large-sized and medium-sized artworks and/or texts.

When the user attention goes back to the IM session, the uncluttered transcript lets the user quickly re-read, or glimpse through, the last few messages of the session, thus enabling the user to recall the point of communication instantly. This is an advantage for both large-sized and medium-sized artworks and/or texts.

FIGS. 5A, 5B, and 5C depict the same prior art embodiment in three progressive time instances. In FIG. 5A the recipient's client has not yet received an artwork. In FIG. 5B the recipient's client has received a medium-sized artwork 115 and is displaying it in the recipient's session window 100. It is noticeable that without a large-sized session window 100 the recipient cannot enjoy large-sized artworks. The user can only enjoy medium-sized artworks, and the emotional impact delivered by the artwork is not at its best because its placement is not optimal. Also, the text 112, “I let you guess what I did . . . ”, which is the actual message the artwork is supposed to highlight, is somewhat lost in the background. In FIG. 5C the recipient, after enjoying the artwork, is ready to send a text reply. It is noticeable that the area used to display the artwork is fixed in size and the cluttering of the transcript prevents the user from quickly re-reading the last few messages of the session.

FIGS. 6A, 6B, and 6C depict how the preferred embodiment of the herein described invention looks in the same, aforementioned three instances. In FIG. 6A the recipient's client has not yet received an artwork. In FIG. 6B the recipient's client has received an overlaid message and is presenting it. The presentation 710 is overlaying the recipient's session window 100. It is noticeable that the user can enjoy large-sized artworks, even on a small-sized session window 100, and the emotional impact delivered by the artwork is at its best thanks to proper placement and to a stand out effect created by the cleared area 717 which is surrounding presentation 710. The presentation 710 comprises the artwork 711 and the sender supplied text 712, “I let you guess what I did . . . ”, which is the actual message the sender wants to highlight, along with the artwork representing the joy of having won. In FIG. 6C the recipient, after enjoying the presentation, is ready to send a text reply. It is noticeable that, because the presentation remains in place only a brief period of time, the area used by the artwork is not fixed in size and is now small. The overlaid message is now displayed as a reminder 715, and it does not clutter the transcript, letting the user quickly re-read the last few messages of the session.

The artwork chosen for the aforementioned example is a “smiley” because it is one of the most popular artworks sent these days. The disadvantages of prior art embodiments limit the user to only few and simple artworks. The invention herein described overcomes the disadvantages of prior art embodiment and empowers the user to use and enjoy an unlimited number of new and richer artworks. For example, the prior art limitations prevent prior arts from showing an artwork that animates flowers blossoming out of the session window, or an artwork that animates a toy airplane flying across the screen. On the other hand, the invention herein described enables such artworks to be shown and to achieve a substantial emotional impact.

### BRIEF DESCRIPTION OF THE DRAWINGS

FIG. 1A provides an example of a presentation overlaying a session window;

FIG. 1B provides an example of a reminder displayed within a transcript area;

FIG. 2 provides a general overview of a computer communication network;

FIG. 3A provides an example of a client user interface for a desktop computer;

FIG. 3B provides an example of a client user interface for a PDA;

FIG. 4A through 4D provides examples of prior arts;

FIGS. 5A, 5B, and 5C provide an example of a prior art embodiment in progressive time instances;

FIGS. 6A, 6B, and 6C provide an example of a preferred embodiment in progressive time instances;

FIG. 7 provides a flow-chart of a selection, delivery, and presentation sequence;

FIGS. 8A, 8B, 8C, and 8D provide examples of presentations having same artwork and different text;

FIGS. 9A, 9B, and 9C provide examples of a selection process from a favorite's repository;

FIGS. 10A and 10B provide examples of a selection process from a host system repository;

FIGS. 11A and 11B provide examples of presentations of shortcut generated overlaid messages;

FIGS. 12A through 15B provide examples of presentations of textual input generated overlaid messages;

FIGS. 16A, 16B, 16C, and 16D provide examples of textual input assistance;

FIGS. 17A, 17B, 17C, and 17D provide examples of presentation preview parameter editing;

FIGS. 18A, 18B, 18C, and 18D provide examples of graphic processing applied to the text of an overlaid messages;

FIGS. 19A, 19B, 19C, and 19D provide examples of graphic processing applied to the artwork of an overlaid message;

FIGS. 20A and 20B provide examples of graphic processing applied to an overlaid message;

FIGS. 21A and 21B provide examples of presentations bordered by a graphic processing alteration;

FIGS. 22A, 22B, 22C, and 22D provide examples of presentation placement positions;

FIGS. 23A, 23B, 23C, and 23D provide examples of presentation sizes;

FIGS. 24A, 24B, 24C, and 24D provide examples of presentation transparencies;

FIGS. 25A through 26C provide examples of presentations along three temporal phases;

FIGS. 27A through 27C provide examples of presentations within areas of a session window;

FIGS. 28A through 28E provide examples of presentations within an overlaid window;

FIGS. 28A and 28B provide examples of reminders;

FIG. 30A, 30B, and 30C provide examples of marks of capability to delivery and display;

FIGS. 31 and 32 provide flow-charts of transmission algorithms;

FIG. 33 provides a flow-chart of a substitution algorithm; and

FIGS. 34 through 44 provide examples of two users exchanging overlaid messages.

### DETAILED DESCRIPTION OF THE INVENTION

The herein specified invention start from the idea to make a communication more entertaining by means of magnifying and overlaying messages themselves. Once a message is magnified, its liveliness can be enhanced by means of colors, styles, animations, and artworks.

In the preferred embodiment, an overlaid message is a message, e.g. texts, graphics, images, animations, movies, or any combination of them, with or without sounds, delivered from a sender's instant message client to at least one recipient's instant message client. Such message is typically meant to be displayed, e.g. displayed, played, made visible, or otherwise enabled to be perceived, upon recipient's client system input and it often overlays the recipient's session window, or any chosen area of the recipient's client system screen, for a brief period of time, and optionally is inserted in the transcript of the recipient's session window, small-sized or, for example, otherwise transformed, represented, or indicated.

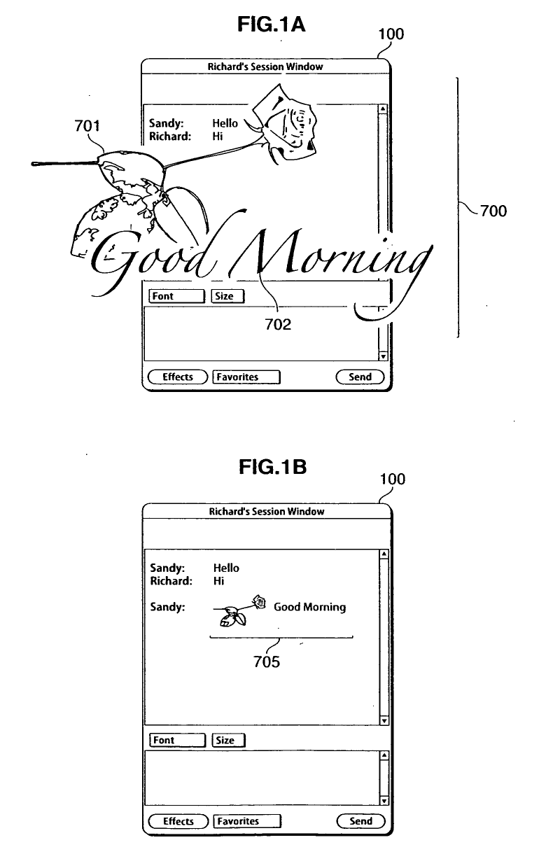

For the preferred embodiment, FIG. 1A depicts an overlaid message presentation 700, i.e. a “presentation”, that overlays the recipient's session window 100. The presentation 700 is composed by an artwork 701, showing a horizontal rose, and sender supplied text 702 “Good Morning.” FIG. 1B depicts an overlaid message reminder 705, i.e. a “reminder”, displayed in the transcript area of the recipient's session window.

In an alternative embodiment, an overlaid message is a message, e.g. texts, graphics, images, animations, movies, or any combination of them, with or without sounds, delivered from the sender's client to at least one recipient's client that typically is meant to be automatically or manually displayed, e.g. displayed, played, made visible, or otherwise enabled to be perceived, for a brief period of time, usually in a preset area of the recipient's client user interface, e.g. a preset window, a preset window that becomes visible to allow a presentation and then may disappear, a preset pane that expands from a window to allow a presentation and then may retract, a preset portion of the user interface reserved for presentations, or a preset portion of the user interface transiently cleared to allow a presentation. Such message may be inserted in the transcript of the recipient's session window, small-sized or, for example, otherwise transformed, represented, or indicated.

The following description defines a typical instant message environment.

Typically, instant message (IM) communications involve an instantaneous or nearly instantaneous communication between two or more users, where each user is able to transmit, receive, and display communicated information. Additionally, although IM communications may occur in the absence of online presence information, IM communication generally involves the display and perception of online presence information regarding other selected users (“buddies”.) After a communication session is established or authentication is performed, the IM communications may be machine-to-machine communications that occur without intervention by, or communication through, an instant messaging server. Examples of IM communications exist over AIM (America Online Instant Messenger), AOL (America Online) buddy list and Instant Messenger, Yahoo Messenger, MSN Messenger, and ICQ, among others.

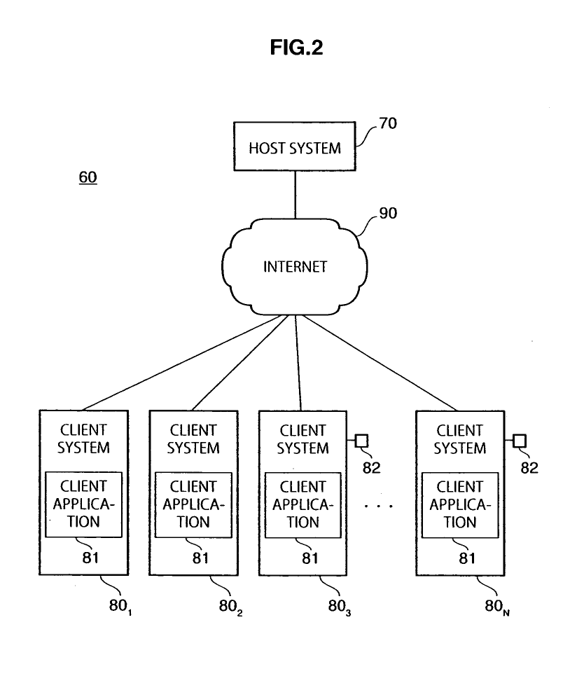

FIG. 2 illustrates a general overview of a computer communication network 60 including a host system 70, i.e. an IM server. In computer network 60, client systems 80.sub.1 to 80.sub.N, i.e. IM client systems, are coupled through the Internet 90, or other communication network, to the host system 70. Only one host system 70 is shown, but it is understood that more than one host system can be used and that other servers providing additional functionality may also be interconnected in network 60 directly, over a LAN or a WAN, or over the Internet. Several elements in the system shown in FIG. 2 are conventional, well-known elements that need not be explained in detail here.

The herein described invention is suitable for use with the Internet, which for purposes of the discussion herein refers to a specific global inter-network of networks. However, it should be understood that other networks can be used instead of the Internet, such as an intranet, an extranet, a virtual private network (VPN), a wireless network, e.g. GPRS, an ATM network, non-TCP/IP based network, or the like.

According to one embodiment, the host system 70 and all of its components are operator-configurable using computer code run using a central processing unit. Computer code for operating and configuring the host system 70 is preferably stored on a hard disk, but the entire program code, or portions thereof, may also be stored in any other memory device, such as a ROM or RAM, or provided program code, such as a compact disk medium, a floppy disk, or the like.

Each client system 80, for example, could be a desktop personal computer, workstation, cellular telephone, personal digital assistant (PDA), music or video player, laptop, or any other computing device capable of interfacing directly or indirectly to the Internet. Each client system 80 also typically includes one or more user interface devices 82, such as a keyboard, a mouse, touch-screen, pen or the like, for interacting with a client 81, i.e. an IM client application, by means of a client user interface, i.e. a graphical user interface provided by client itself, and for interacting with any other application, program, and software or similar entity by means of their respective user interfaces.

An example of a client 81 is a software application loaded on the client system 80 for commanding and directing communications enabled by the client system 80. Other examples include a program, a piece of code, an instruction, a firmware, an embedded capability, a device, a computer, a computer system, or a combination of these for independently or collectively instructing the client system 80 to interact with the host system 70 and operate as described. The client 81 may be embodied permanently or temporarily in any type of machine, component, physical or virtual equipment, storage medium, or propagated signal capable of providing instructions to the client system 80.

A client 81 could also be software which primary use is not for instant messaging, but nevertheless, has full or partial instant messaging capabilities, for example, a multipurpose communication software, e.g. America Online Inc., AOL 9.0, IRC software, word processing and spreadsheet applications having networking capabilities, web browsers, e.g. Mozilla or Netscape Communicator, web browsers in conjunction with instruction received from a web site, e.g. AIM Express, and video, audio, or multimedia communication software.

To access the host system 70 to begin an IM session in the implementation of FIG. 2, the client system 80.sub.1 establishes a connection to the host system 70. Once the connection to the host system 70 has been established, the client system 80.sub.1 may directly or indirectly transmit data to, and access content from, the host system 70. By accessing the host system 70, a user can use the client 81 to view whether particular users (“buddies”) are online, exchange IMs with particular buddies, participate in group chat rooms, trade files such as pictures, invitations or documents, and find other buddies with similar interests. The client system 80.sub.2 may be similarly manipulated to establish contemporaneous connection with the host system 70. In certain system embodiments, the client system 80 may act as a substitutive equivalent of the host system 70 to other client systems 80, e.g. a Gnutella-like or Limewire-like decentralized P2P communication network.

Once connectivity is established, a user who is using the client system 80.sub.1 may view whether a second user operating, for example, the client system 80.sub.2 is online, and typically may view whether the second user is able to receive IMs. If the second user is online, the user operating the client system 80.sub.1 may exchange IMs with the second user. In one implementation, the IMs sent between the client system 80.sub.1 and the client system 80.sub.2 are routed through the host system 70. In another implementation, the IMs sent between the client system 80.sub.1 and the client system 80.sub.2 are routed through a third party server (not shown), and, in some cases, are also routed through the host system 70. In yet another implementation, the IMs are sent directly between the client system 80.sub.1 and the client system 80.sub.2.

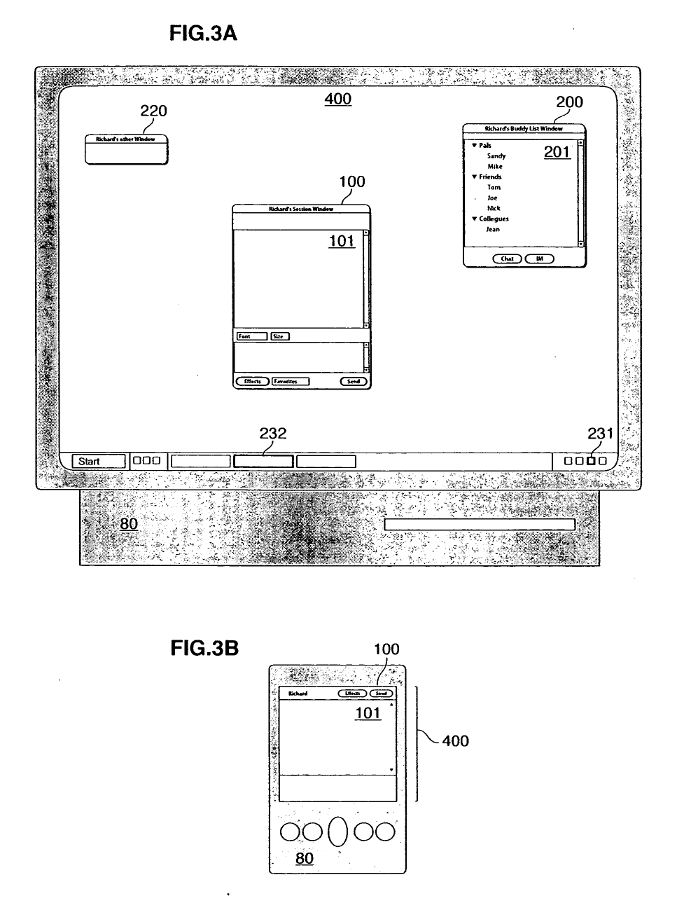

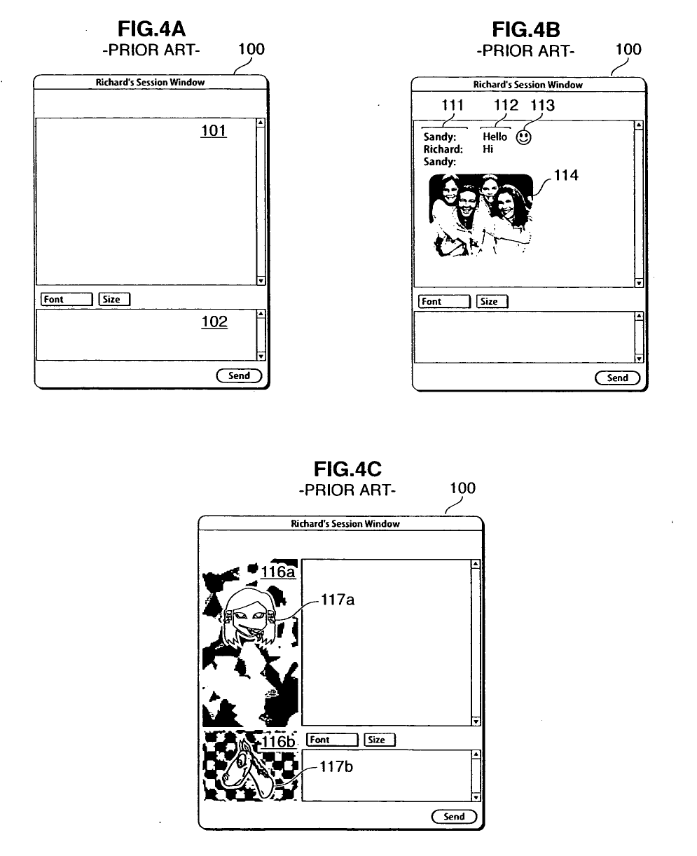

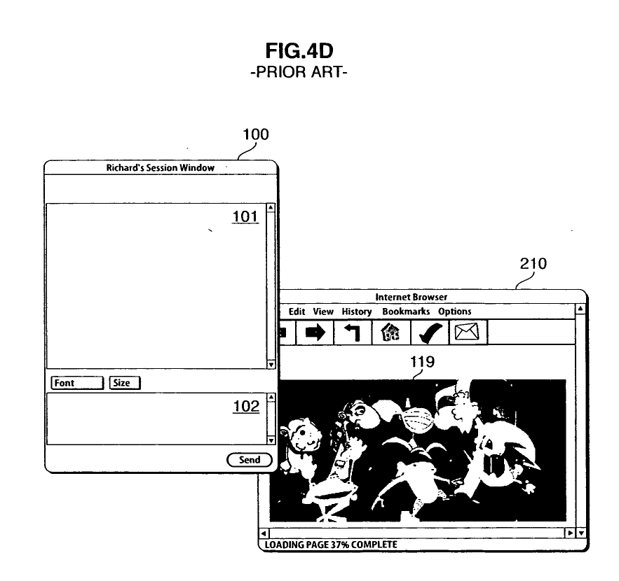

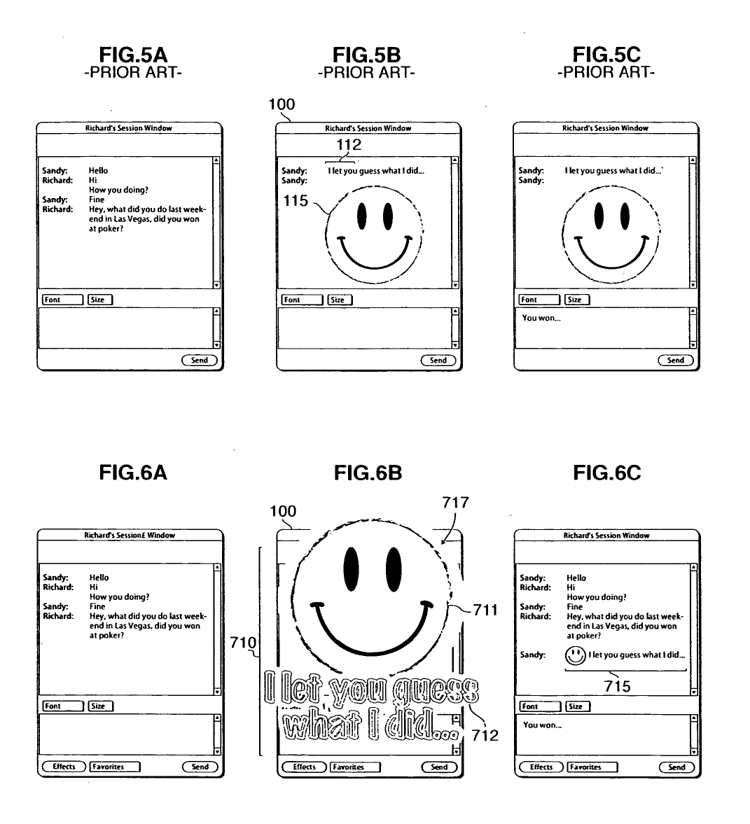

The client user interface is the graphic user interface generated by the client 81 to display to the user information related, for the most part, to the IM communication. Referring to FIG. 3A, in one embodiment where the client system 80 is, for example, a desktop computer, the client user interface is usually constituted by one or more session windows 100, a buddy list window 200, and often, other miscellaneous windows, e.g. window 220. The client user interface also usually comprises one, or more, of the icon 231 and window locator 232 related to the client 81 of FIG. 2.

Referring to FIG. 3B, in one embodiment where the client system 80 is, for example, a PDA, the visible portion of the client user interface usually alternates, due to the small size of the screen, between a session windows 100, a buddy list window, and other miscellaneous windows.

Referring to FIGS. 3A and FIG. 3B, the session window 100 typically contains, among other user interface items, the transcript area 101. The transcript area contains the visible portion of the transcript of the IMs that have been exchanged between the user of the client system 80 and the other users participating in the IM session. Hence, the terms transcript and transcript area are herein used.

To clarify, the client system is usually a hardware entity. The client is usually a software entity having a client user interface comprising the session window and often other windows, e.g. a buddy list window and frequently other session windows. The session window typically comprises the transcript area, where the user can see the IMs exchanged during the session. The sender and the recipient are usually human beings, although sometimes they can be hardware or software automated processes. A user is alternately sender or recipient depending whether he is sending an IM or receiving one. Typically, a user swaps between the roles of sender and recipient every few seconds. The following description introduces the basic overlaid messages concepts.

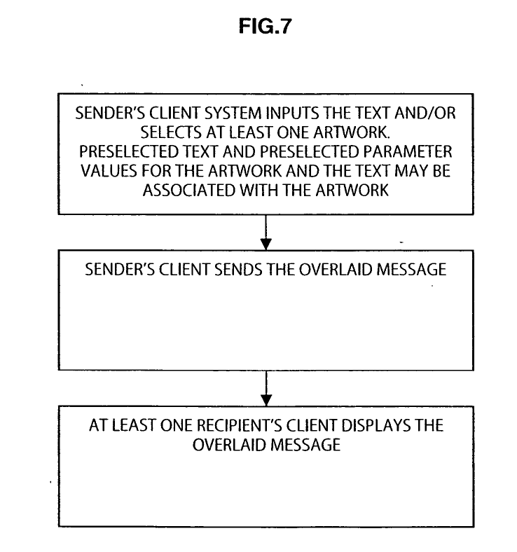

FIG. 7 shows, for the preferred embodiment, the flow-chart of an overlaid message selection, delivery, and presentation sequence.

In the preferred embodiment, the shape, content, transparency, and movement of the presentation of an overlaid message depend on the artwork, text, and parameter settings of the overlaid message and, also, on the recipient's client system elaboration of the artwork and text. Conversationally speaking, overlaid message, for example, artworks, preset texts, and preset parameters, are meant to be supplied in a variety of styles, one different from another. For example, one overlaid message may show a rose, another may show a coffee mug, while others may show kissing lips, a thumbs-up, an airplane, or just text.

In an alternative embodiment, the overlaid message may be set, for example, to be centered on the recipient's client system screen, typically positioned near a corner of the recipient's client system screen, or typically positioned on one or more preset areas of the recipient's client system screen.

The following description focuses on overlaid message text and parameters.

In the preferred embodiment, an overlaid message text is usually supplied by the sender an overlaid message templates may have default text that, typically, the sender may edit and personalize.

The overlaid message may have parameters, for example, its presentation size, position, and duration. The parameters may be user selectable.

Some parameters may be specific to the overlaid message itself, e.g. overlaid message X, “Rose Bud,” has a parameter for the color of the rose; overlaid message Y, “Airplane,” has a parameter for the shape of the airplane. The sender's client may enable the sender to modify the parameters of the overlaid message to select the preferred emotional impact to be delivered to the recipient, e.g. choosing a large-sized presentation versus a small-sized one or a 3D versus a 2D one.

An overlaid message may comprise parameters to artistically integrate the rendering of the text with the artwork. An overlaid message templates may have default parameters values preset to artistically integrate the rendering of the text with the artwork.

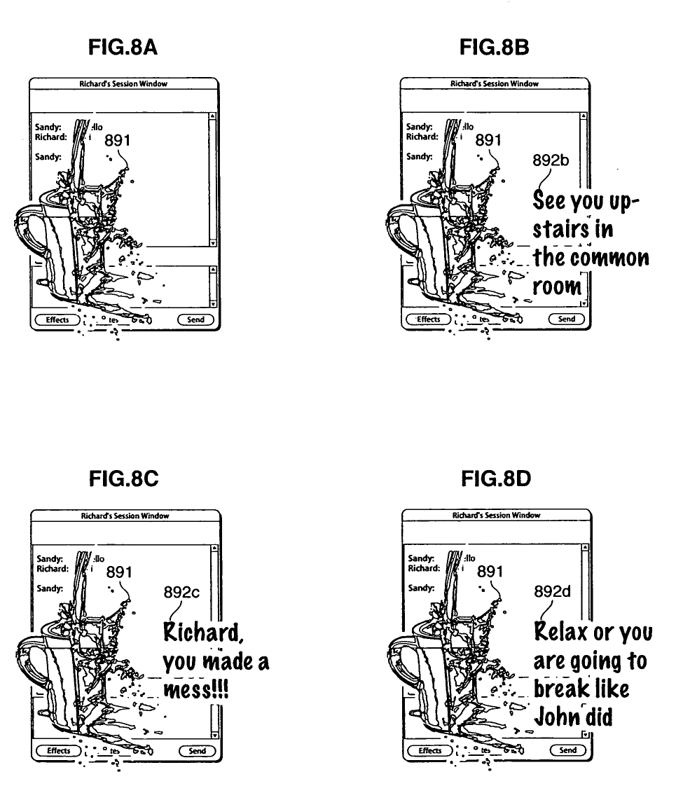

FIGS. 8A, 8B, 8C, and 8D provide examples of overlaid messages comprising the same artwork with, for each example, different text. As it is noticeable, the inclusion of the text in the overlaid message brings different meanings to it.

In FIG. 8A the presentation comprises an artwork 891 but no text, and it is noticeable that the overlaid message has little meaning. In FIG. 8B the presentation comprises an artwork 891 and the text 892b, “See you upstairs in the common room”, and it is an easy guess that the meaning of the message is for the sender and the recipient to meet upstairs for a cup of coffee.

In FIG. 8C the presentation comprises an artwork 891 and the text 892c, “Richard, you made made a mess!!!”, and it is an easy guess that the meaning of the message is for the sender to complain about some of the recipient's actions. In FIG. 8D the presentation comprises an artwork 891 and the text 892d, “Relax or you are going to break like John did”, and it is an easy guess that the meaning of the message is for the sender to voice a note of caution on the recipient's workload.

Text may be, for example, also, or only, in spoken form. The sender's client may enable the sender, for example, to add a spoken text, or to modify a default one. A client may, for example, produce a presentation with a written and/or a spoken text. A client may also, for example, use a text-to-speech synthesis to convert a written text into a spoken one, or use a speech-to-text recognition to convert a spoken text into a written one.

In the preferred embodiment, the recipient's client may automatically override the parameters of an incoming overlaid message to limit or enhance the emotional impact of the overlaid message, e.g. forcing the presentation to be scaled to a smaller size, or grown to a larger size. The recipient's client may enable the recipient to customize, e.g. set or reset, some or all of the parameter overriding features, for example, per overlaid message, per overlaid message classification, per IM session, per sender, or always.

The following description focuses on the supply of overlaid messages.

In the preferred embodiment, the sender's client may have access to one or more local and/or remote, e.g. supplied by the host system, repositories of overlaid message templates comprising, for examples, artworks, preset text, and preset parameters, e.g. to instruct a 3D rendering of text. One or more local repositories may be preset to contain overlaid message templates that are distributed with the sender's client itself and do not require retrieval from the host system. One or more repositories may be updated, for example, on a temporal basis to add new overlaid message templates. The sender's client and/or the host system may keep current one or more repositories containing a subset of the overlaid message templates that have already been used by the sender. The sender can select an overlaid message template from one of the repositories to, for example, preview, send an overlaid message, and/or add the templates another repository, e.g. the sender's repository of favorite overlaid messages.

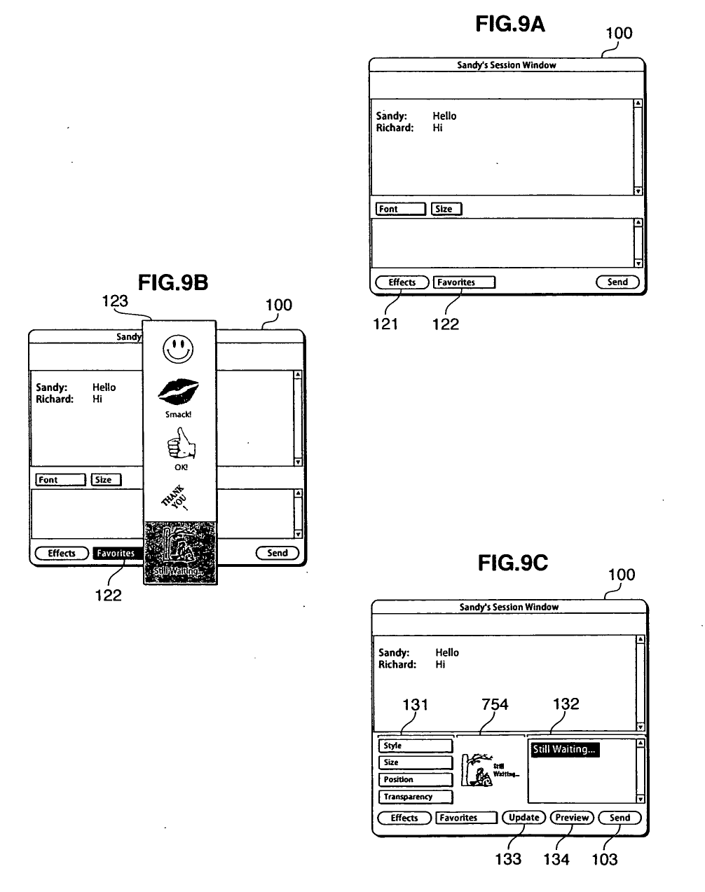

For the preferred embodiment, FIG. 9A depicts the sender's session window 100. The sender may begin the selection of an overlaid message template by clicking on the effects button 121 or on the favorites popup control 122. FIG. 9B depicts the favorites selection process where the sender selects an overlaid message template from the favorites menu 123 that opens when the sender clicks on the favorites popup control 122. Once the overlaid message template is selected, the overlaid message generated from the template is ready to be sent; the sender may edit the overlaid message before sending it. FIG. 9C depicts the sender's session window showing the simulated presentation 754. The user interface for parameter editing 131 and for text editing 132 lets the sender modify the parameter settings of the overlaid message and customize its text. When the sender changes the parameter settings or the text, the sender may update the simulated presentation 754 by clicking on the update button 133. The sender may also preview the actual presentation by clicking on the preview button 134. When satisfied with the customization, the sender may send the overlaid message by clicking on the send button 103.

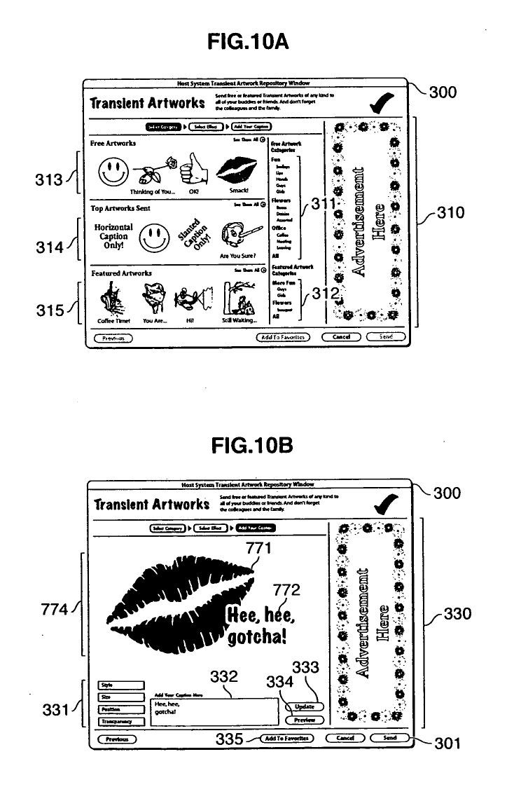

Referring again to FIG. 9A, when the sender selects the effects button 121 the selection process from a host system based overlaid message template repository begins. FIG. 10A depicts the first step of the selection process from a repository window 300. During the first step, the repository window 300 shows the overlaid message selection pane 310 from which the sender may pick a template from the “Free Artworks” category 313, “Top Artworks Sent” category 314, and “Featured Artwork” category 315, or a directory of categories such as “Free Artwork Categories” 311 and “Featured Artwork Categories” 312.

FIG. 10B depicts the second step of the selection process. The overlaid message text and parameters editing pane 330 enable the sender to edit the text 772 using the text editing user interface 332, and to set the parameters of the overlaid message using the parameter editing user interface 331. When the sender changes the text or the parameter settings, the sender may update the simulated presentation 774 by clicking on the update button 333. The sender may also preview the actual presentation by clicking on the preview button 334. When satisfied with the customization, the sender may send the overlaid message by clicking on the send button 301, or may add it to his repository of favorites by clicking on the Add To Favorites button 335.

In an alternative embodiment, the overlaid message template may be supplied by a separate application. The overlaid message template may be supplied through, for example, an HTTP or FTP connection with the host system and/or with another server, or the overlaid message template may be supplied within, for example, HTML or XML data supplied by the host system and/or another server. In an alternative embodiment, an overlaid message artwork may also be supplied by an editing feature of the sender's client or a separate application that enables the sender to create his own overlaid message artworks from scratch and/or to assemble them from pre-made artwork components supplied, for example, by the host system and/or other server. In particular, the sender's client or separate application may enable the user to create personalized overlaid message artworks that contains user pictures, for example, pictures of family or friends.

The following description focuses on the generation of overlaid messages by means of shortcuts.

In the preferred embodiment, the sender's client may enable the sender to generate an overlaid message, and optionally select its parameters and/or supply its text, by typing a shortcut, for example, within the message composition area or elsewhere in the client user interface. The shortcut may comprise, for example, an identification string, one or more parameter strings, and/or a text string. The sender's client may enable the sender to create and/or edit a list of shortcuts and the shortcut association with an overlaid message or a favorite.

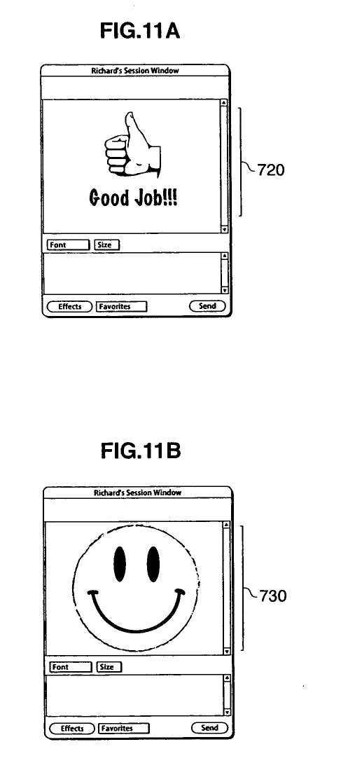

For example, the sender may create a “˜˜thumbup” shortcut. When the sender types it along with a “Good Job!!!” text string, i.e. the sender would type “Good Job!!!˜˜thumbup”, which comprises a ‘˜˜thumbup’ identification string and a ‘Good Job!!!’ text string, he generates and supplies the text for the overlaid message which presentation 720 is shown in FIG. 11A. To obtain the same result, the sender may also, or instead, create, for example, an even shorter shortcut, “**gj”, and associate it to a favorite, which specifies the same overlaid message of the previous example and also the parameters and the text, e.g. “Good Job!!!,” to be used with it. When the sender types “**gj” the overlaid message, which presentation 720 is shown in FIG. 11A, is generated. Another example would be a “++:-)” shortcut, or even as simple as “:-)”, that generates the overlaid message which presentation 730 is shown in FIG. 11B.

The following description focuses on the generation of overlaid messages by means of textual input.

In the preferred embodiment, the sender's client may enable the sender to generate an overlaid message by means of textual input and assisted textual input.

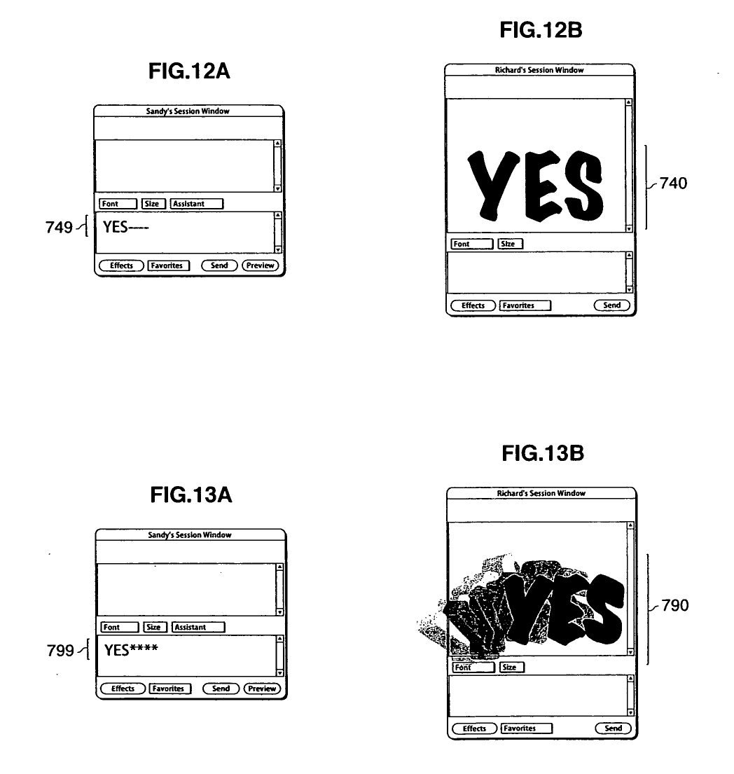

In the example of FIG. 12A, the sender inputted the string 749, “YES----”. The string “YES----” comprises the text of the overlaid message, “YES”, and a selector for a type of overlaid message, “----”. The dash, “-”, indicates an overlaid message with no graphical processing, and the number of dashes, “-”, indicates the size of the presentation, in this case a medium one. Alternative embodiments may use different characters in place of the dash, “-”. The example of FIG. 12B shows the presentation 740 which is the presentation of the overlaid message inputted in FIG. 12A.

Alternative embodiments may use different notations to indicate the size of the presentation, for example, numbers, e.g. “--4”, letters, e.g. “--M”, or keywords, e.g. “--MEDIUM”. Also, alternative embodiments may use different character combinations other than the double dash, “--”.

In the example of FIG. 13A, the sender inputted the string 799, “YES****”. The string “YES****” comprises the text of the overlaid message, “YES”, and a selector for a type of overlaid message, “****”. The asterisk, “*”, indicates an overlaid message with a “3D” graphical processing, and the number of asterisks indicates the size of the presentation. The example of FIG. 13B shows the presentation 790 which is the presentation of the overlaid message inputted in FIG. 13A.

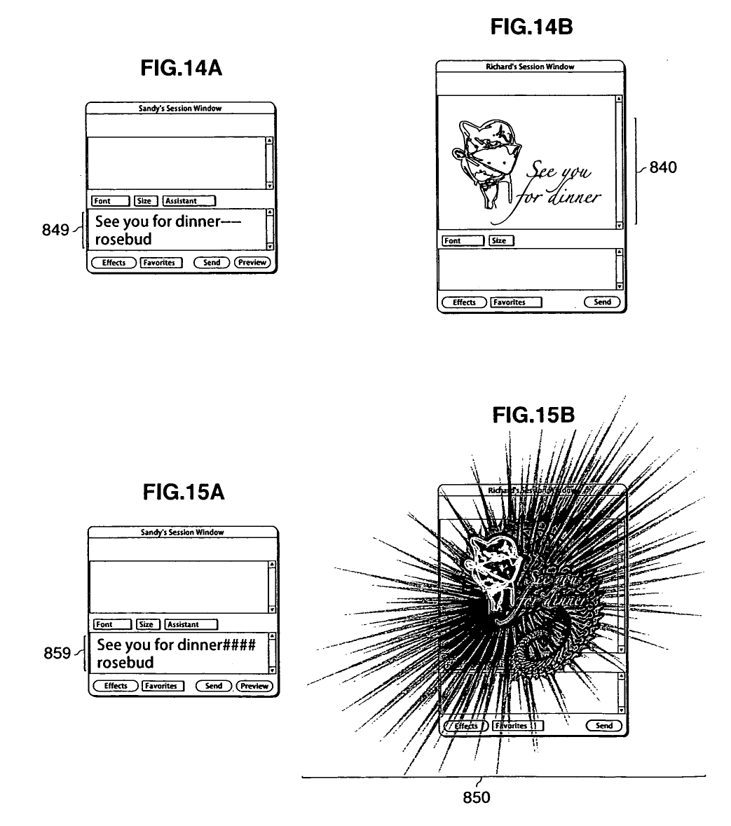

In the example of FIG. 14A, the sender inputted the string 849, “See you for dinner---rosebud”. The string “See you for dinner----rosebud” comprises the text of the overlaid message, “See you for dinner”, a selector for a type of overlaid message, “----”, and a selector for an artwork, “rosebud”. The dash, “-”, indicates an overlaid message with no graphical processing, and the number of dashes indicates the size of the presentation. The “rosebud” artwork has a preset parameter for the font type of the overlaid message text, so the sender has no need to specify the artistic font type. The example of FIG. 14B shows the presentation 840 which is the presentation of the overlaid message inputted in FIG. 14A.

In the example of FIG. 15A, the sender inputted the string 859, “See you for dinner####rosebud”. The string “See you for dinner####rosebud” comprises the text of the overlaid message, “See you for dinner”, a selector for a type of overlaid message, “###”, and a selector for an artwork, “rosebud”. The number-sign, “#”, indicates an overlaid message with a “flare” graphical processing, and the number of number-signs indicates the size of the presentation. The “rosebud” artwork has a preset parameter for the font type of the overlaid message text, so the sender has no need to specify the artistic font type. The example of FIG. 15B shows the presentation 850 which is the presentation of the overlaid message inputted in FIG. 15A.

In the preferred embodiment the sender's client user interface may provide assistance to the textual input.

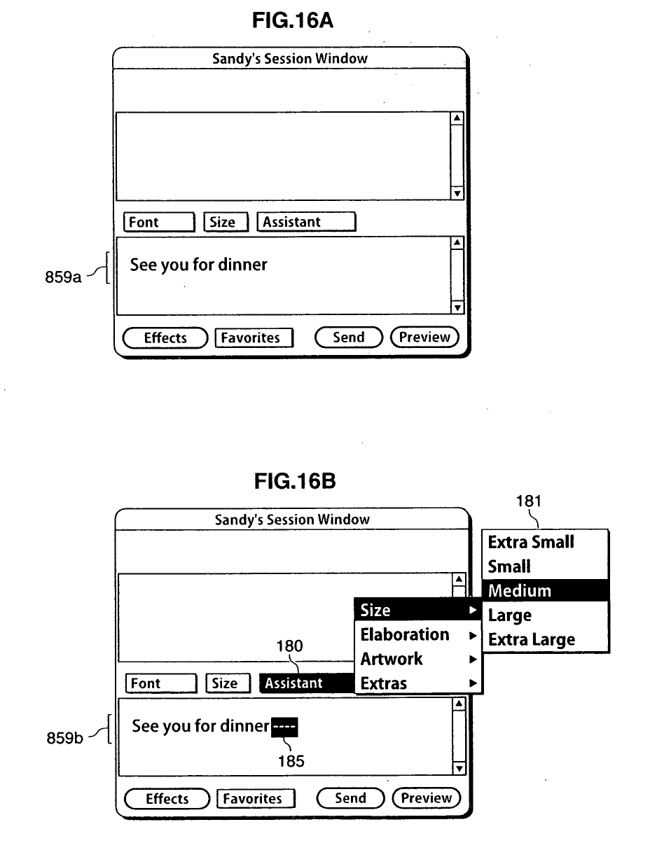

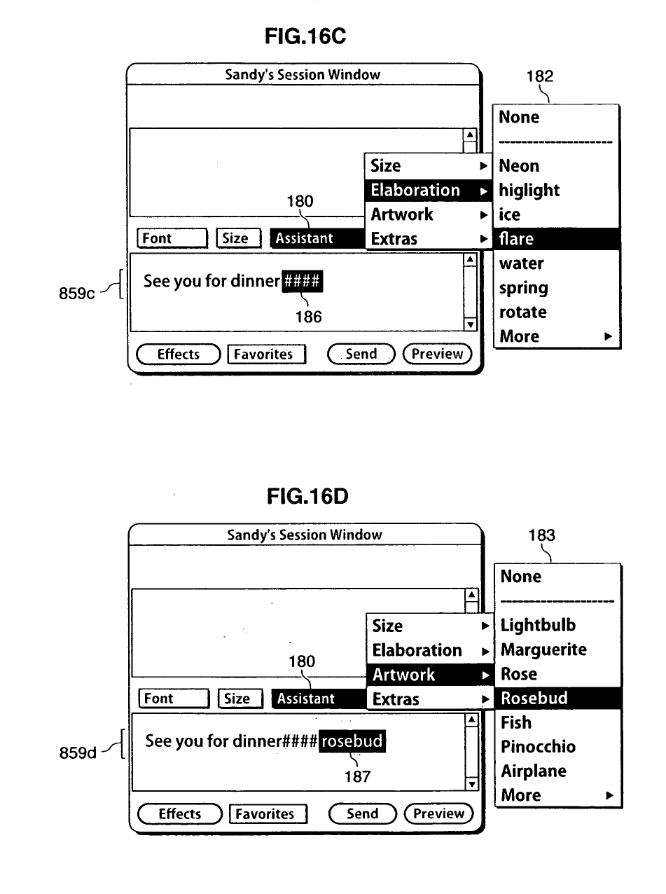

FIGS. 16A, 16B, 16C, and 16D are all part of the same example in progressive time instances. In FIG. 16A the sender has just inputted the text of the “to become” overlaid message, but for now the sender is only operating on a regular message. In FIG. 16B the sender transforms the “to become” overlaid message into an actual overlaid message. FIG. 16C the sender selects the graphical processing to be applied to the presentation of the overlaid message. FIG. 16D the sender selects an artwork to be included in the overlaid message.

In FIG. 16A, the sender inputted the string 859a, “See you for dinner”.

In FIG. 16B, the sender selected the assistant popup menu 180 and from the sub-menu 181, “size”, chooses a medium size for the presentation. The choice is reflected in the string 859b, “See you for dinner----” which now contains the sub-string 185, “----”. The sub-string “----” indicates an overlaid message of medium size with no graphical processing.

In FIG. 16C, the sender selected the assistant popup menu 180 and from the sub-menu 182, “elaboration”, chooses a “flare” graphical processing to be applied to the presentation. The choice is reflected in the string 859c, “See you for dinner####” that now contains the sub-string 186, “####” in substitution of the string “----”. The sub-string “####” indicates an overlaid message of medium size with “flare” graphical processing.

In FIG. 16D, the sender selected the assistant popup menu 180 and from the sub-menu 183, “artwork”, chooses a “rosebud” artwork to be included in the overlaid message. The choice is reflected in the string 859d, “See you for dinner####rosebud” that now contains the sub-string 187, “rosebud”. The sub-string “rosebud” indicates the inclusion of the “rosebud” artwork into the overlaid message.

In an alternative embodiment, for example, the sender's client may enable the sender to customize the association between a symbol, e.g. a dash, “-”, and the type of overlaid message, e.g. with no graphical processing. For example, a sender may choose to use the exclamation mark, “!”, instead of the dash, “-”, to select a type of overlaid message with no graphical processing.

In an alternative embodiment, for example, an assisted textual input may modify the parameters of the presentation without adding sub-strings to the overlaid message string.

Textual input allows very fast creation of overlaid messages. Textual input greatly enhances the easiness and encourages frequent use of overlaid messages.

The following description focuses on the preview of the presentation of overlaid messages.

In the preferred embodiment, the sender's client may enable the sender to preview the presentation of an overlaid message before to send it by, for example, changing the send button into a preview button when the generation of an overlaid message by the sender is in progress. While the overlaid message is previewed, the sender's client may enable the sender to modify the overlaid message parameters, text, and artworks and to see the changes immediately reflected in the preview. The preview may be, for example, identical, similar, or a reduced version of the presentation to be displayed on the recipient's client system.

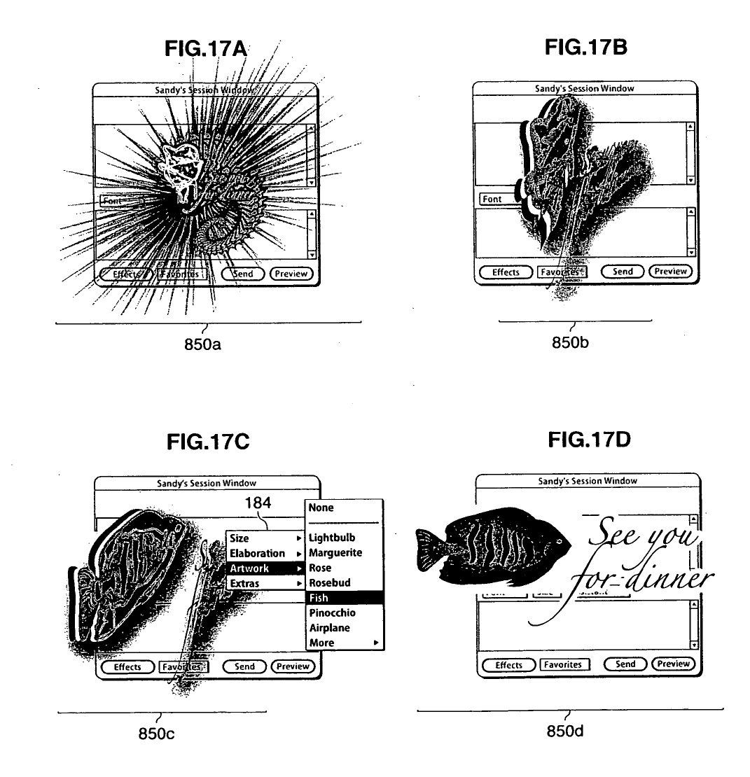

FIGS. 17A, 17B, 17C, and 17D are all part of the same example in progressive time instances. In FIG. 17A, the sender just started the preview process with the preview 850a. In FIG. 17B, the sender, by means of keystrokes, swapped the graphic processing of the presentation into a “3D” graphic processing as shown in the preview 850b. In FIG. 17C, the sender, by means of mouse clicks, exchanged the artwork of the presentation into a “fish” artwork as shown in the preview 850c. In FIG. 17D, the sender by means of keystrokes swapped the graphic processing of the presentation into a no graphic processing as shown in the preview 850d.

In FIG. 17A, the sender is previewing the presentation 850a. By means of, for example, at least one keystroke and/or at least one mouse click he may change the overlaid message parameters, text, and artworks to produce a presentation like the presentation 850b shown in the example of FIG. 17B.

During a preview, for example, the keys up-arrow and down-arrow may respectively increase and decrease the presentation size. Also for example the keys left-arrow and right-arrow may select respectively the previous and next available graphical processing, and the keys “<” and “>” may select respectively the previous and next available artwork.

During a preview, for example, a left-click on the preview may bring to visibility the assistant menu 184 of FIG. 17C, from where, for example, the sender may select a different artwork.

The following description focuses on payment for overlaid messages use.

In the preferred embodiment, an overlaid message may be enabled to be transmitted in consideration for a payment. Also, an overlaid message template may be configured to be no longer usable upon the occurrence of a predetermined event, for example, the passage of a predetermined length of time, date, and/or number of transmissions from the original sender.

In consideration for a payment, an overlaid message may be enabled, for example, to have large-sized presentation on the recipient's client system screen, e.g. user A may send without a fee the overlaid message Z, “Spring flowers,” to be presented at a size of 200 by 200 pixels on user B's system screen;. User A may also choose to pay a fee and send the same overlaid message to be presented at a size of 400 by 400 pixels. An overlaid message artwork may be enabled, for example, to have a richer content, e.g. user A can send without a fee the overlaid message artwork T1, “Single Rose version” to user B. User A may also choose to pay a fee to send the overlaid message artwork T2, “Twelve Rose Bucket version.”

In the preferred embodiment, overlaid message templates may have one or more systems of classification. The classification may distinguish among, for example, the overlaid message content rating and suitability for children, teenagers, or adults. Another form of classification may distinguish among, for example, the overlaid message content type such as romance, friendship, love, or workplace.

The following description focuses on the overlaid message presentation.

In the preferred embodiment, the overlaid message may be transiently presented overlaying one or more preset or chosen areas located anywhere on the recipient's client system screen. More specifically, the presentation is often set to overlay the recipient's session window to enhance the delivered emotional impact through, for example, large-sized and/or uncluttered presentations.

In the preferred embodiment, the presentation of an overlaid message usually starts automatically on the recipient's client system screen, once the overlaid message has been at least partially received. Alternatively, the presentation starts after a preset amount of time or only when the reminder is selected by the recipient for presentation.

In the preferred embodiment, the presentation may display the artwork alone, the artwork and/or the text, or the result of a process, e.g. graphic and/or sound processing, applied to the artwork and/or the text by the recipient's client. The process may, for example, change a static artwork and/or a static text into animated ones. The process may also, for example, change the artwork and/or text transparency, size, shape, and/or content. The process may also, for example, change the artwork and/or text transparency, size, shape, and/or content several times within an animated presentation. The process may also, for example, combine the artwork of the overlaid message with other artworks supplied by the recipient's client and/or host system. The process may be applied with input from the parameter settings of the overlaid message. In an alternative embodiment, the presentation may be the result of a process, e.g. graphic and/or sound processing, applied on the artwork and/or the text of the overlaid message by the sender's client and/or host system, i.e. instead of being applied by the recipient's client.

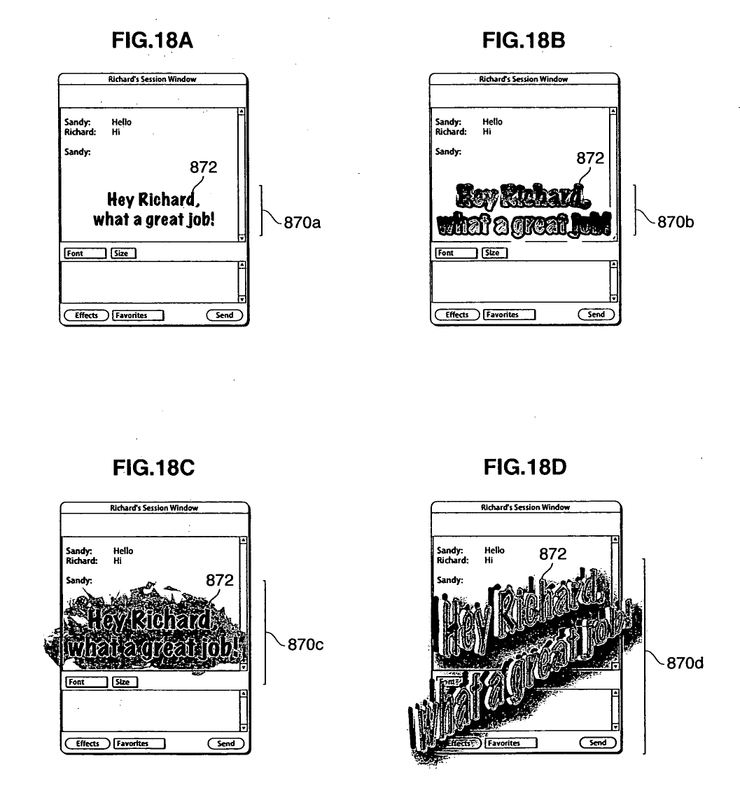

FIGS. 18A, 18B, 18C, and 18D are examples of presentations displaying the same text with different graphic processing applied to it. As it is noticeable, what differentiates the four presentations is the type of graphic processing applied to them.

In FIG. 18A the presentation 870a consists of the text 872, “Hey Richard, what a great job!”, which is displayed with no graphic processing applied to it. In FIG. 18B the presentation 870b consists of the same text 872, “Hey Richard, what a great job!”, displayed with a “metallic” graphic processing applied to it. In FIG. 18C the presentation 870c consists of the same text 872, “Hey Richard, what a great job!”, displayed with a “water” graphic processing applied to it. In FIG. 18D the presentation 870d consists of the same text 872, “Hey Richard, what a great job!”, displayed with a “3D” graphic processing applied to it.

There are several advantages in displaying a colorful and elaborated text over a display of monochrome text. For example, a colorful and elaborated text helps the text be more easily read, to appear detached from the background, to be perceived more lively, to be perceived less monotone, to be perceived warm, to be perceived reinforcing the content of the message, e.g. white and red colors for a message containing the word “NO” and shaded green for a message containing the word “YES”.

There are several advantages in applying graphic processing to the text instead of delivering an artwork displaying the same result. For example, the bandwidth required to transmit text, and an ID to select the graphic processing to be applied on it, is several orders of magnitude lower than transmitting a rastered artwork.

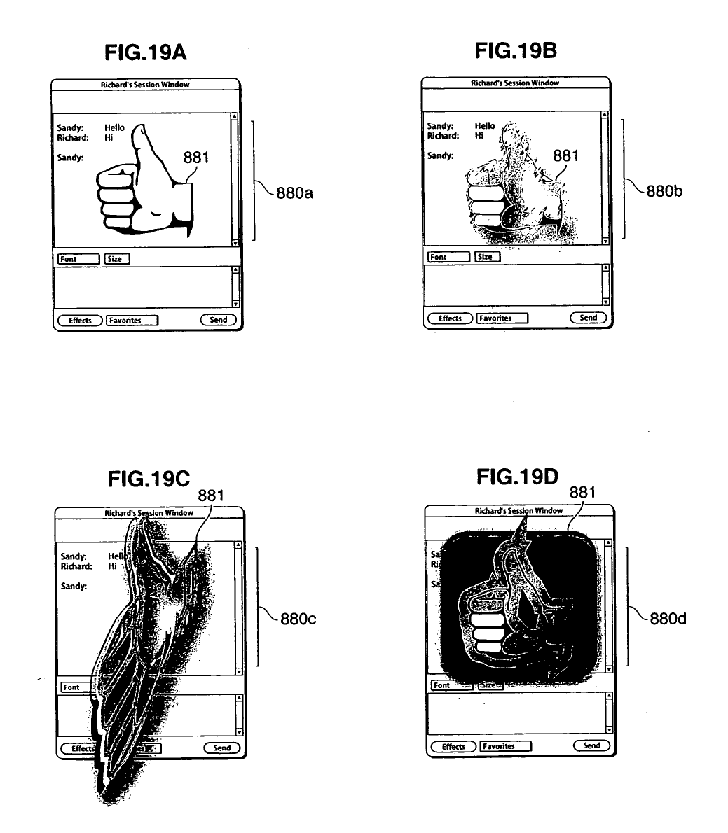

FIGS. 19A, 19B, 19C, and 19D are examples of presentations displaying the same artwork with different graphic processing applied to it. As it is noticeable, what differentiates the four presentations is the type of graphic processing applied to them.

In FIG. 19A the presentation 880a consists of the artwork 881, a thumb up, which is displayed with no graphic processing applied to it. In FIG. 19B the presentation 880b consists of the same artwork 881, a thumb up, displayed with an “electric” graphic processing applied. In FIG. 19C the presentation 880c consists of the same artwork 881, a thumb up, displayed with a “3D” graphic processing applied to it. In FIG. 19D the presentation 880d consists of the same artwork 881, a thumb up, displayed with a “fire” graphic processing applied to it.

There are several advantages in applying different graphic processing to the same base artwork instead of delivering pre-processed artwork each time (i.e., the pre-processed artwork displaying the same result as the base artwork with the graphic processing applied to it.) For example, on the recipient's client, the caching of the artwork is much more efficient e.g., referring to the example of FIGS. 19A, 19B, 19C, and 19D the base artwork is delivered only once, while, if they were all different pre-processed artwork they would require four separate transmissions and roughly four times the amount of data transmitted.

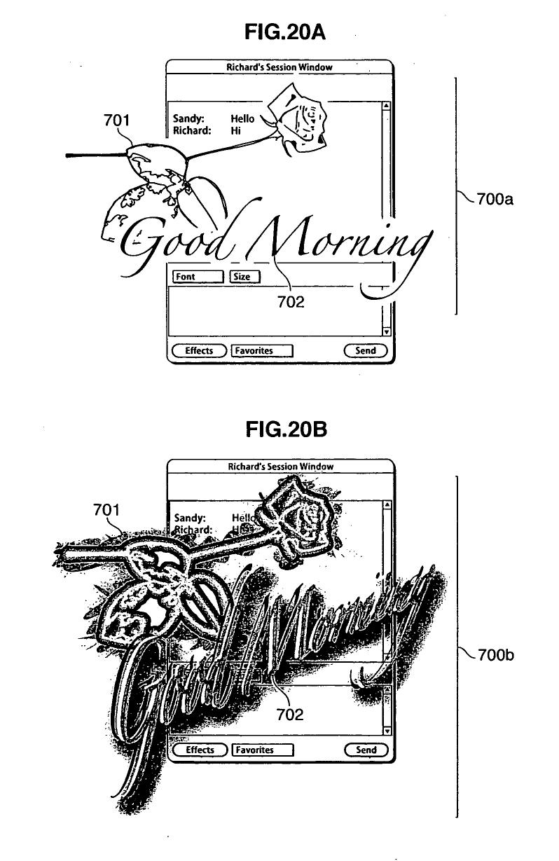

FIGS. 20A and 20B are examples of presentations displaying the same artwork and text with different graphic processing applied to it. As it is noticeable, what differentiates the two presentations is the type of graphic processing applied to them.

In FIG. 20A the presentation 700a consists of the artwork 701, a rose, and of the text 702, “Good Morning”. Both are displayed with no graphic processing applied to them. In FIG. 20B the presentation 700b consists of the same artwork 701, a rose, displayed with a “glowing” graphic processing applied to it, and of the same text 702, “Good Morning”, displayed with a “3D” graphic processing applied to it.

In the preferred embodiment, the presentation may be semi-transparent to let the underlying content be visible. While played, the presentation may change its degree of transparency, grow or shrink in size, move, jump, and/or change its shape and/or content. To accentuate the presented overlaid message's perceived distance from all other entities on the user's system screen, e.g. windows and user interface items, a dimming border may surround the presentation, e.g. the underlying entities are made less visible near the presented overlaid message border. Similarly, to accentuate the presented overlaid message's visibility, a white or colored highlighting border may surround the presentation. To enhance the presentation impact, a graphic processing alteration may be applied to any user interface entity of the recipient's client and/or of any other entity displayed on the recipient client system screen, e.g. a ripple effect that looks like a drop splashing on a liquefied screen.

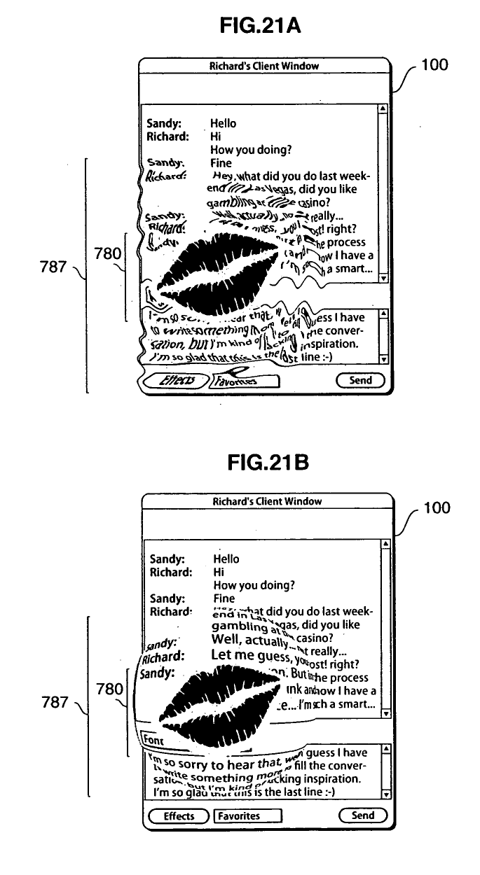

FIG. 21A depicts, for the preferred embodiment, a presentation 780 that is surrounded by a ripple effect graphic processing alteration 787. FIG. 21B depicts, for the preferred embodiment, a presentation 780 that is surrounded by a lens effect graphic processing alteration 787.

In the preferred embodiment, upon recipient and sender settings, the overlaid message, instead of being presented as an overlay, may be presented in the transcript of the recipient's session window as a regular message would be displayed, e.g. displayed within the boundaries of the transcript area and in the proper transcript-sequence position, but still retains the capability to be transformed into a reminder. In an alternative embodiment, the overlaid message is only presentable as a regular message, e.g. displayed within the boundaries of the transcript area and in the proper transcript-sequence position, but still retains the capability to be transformed into a reminder.

In the preferred embodiment, the presentation position is typically a parameter of the overlaid message. The sender's client may enable the sender to choose the presentation position on the recipient's client system screen, e.g. centered on the transcript area of the recipient's session window, centered on the recipient's session window, or centered on recipient's client system screen.

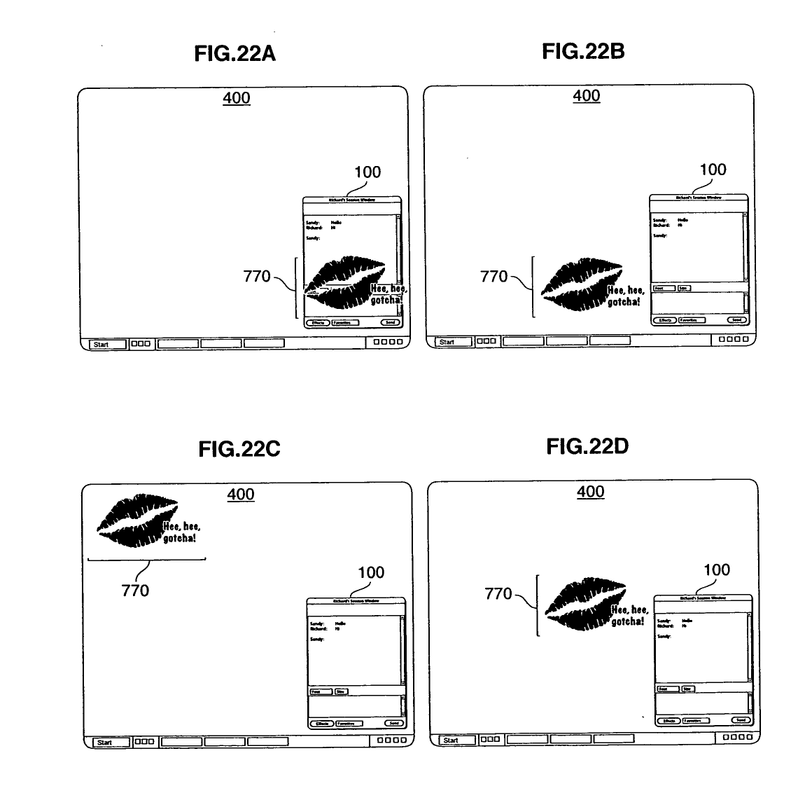

FIGS. 22A, 22B, 22C, and 22D depict, for the preferred embodiment, a presentation 770 at different positions. In FIG. 22A the presentation 770 is positioned overlaying the recipient's session window 100. In FIG. 22B the presentation 770 is positioned next to the recipient's session window 100. In FIG. 22C the presentation 770 is positioned near the top, left corner of the recipient's client system screen 400. In FIG. 22D the presentation 770 is positioned at the center of the recipient's client system screen 400.

The recipient's client may detect when the parameter settings of a presentation result in a presentation that is partially, or completely, out of the recipient's client system screen coordinates, i.e. the presentation is partially, or totally, invisible to the recipient. The recipient's client may then automatically override the parameter settings to force the presentation to be within the recipient's client system screen coordinates, i.e. the presentation is visible to the recipient, for example, overriding the position and/or size parameters of the presentation.

In the preferred embodiment, the size of the presentation is typically a parameter of the overlaid message. The sender's client may enable the sender to choose the size of the presentation, for example, within a minimum and a maximum size, e.g. from 16-by-16 to 1024-by-1024 pixels. Alternatively, the sender's client may enable the sender to choose from a selection that is restricted to a group of default preset sizes or per overlaid message preset sizes, e.g. 64-by-64, 256-by-256, and 512-by-512 pixels, depending, for example, on the scaling possibilities of the presentation and/or the computational capabilities of the recipient's client system. The sender's client may enable the sender to choose from fixed value sizes, e.g. 128-by-128 pixels, or from the recipient's session window relative sizes, e.g. 1 and ½ times the size of the recipient's session window. The sender's client user interface may list the available presentation sizes using a caption along with, or instead of, a numeric representation, e.g. it may list the sizes using the captions “small-discreet,” “medium-fine,” “large-impressive,” and “huge-annoying” along with, or instead of the “128-by-128,” “256-by-256,” “512-by-512,” and “1024-by-1024” numeric labels.

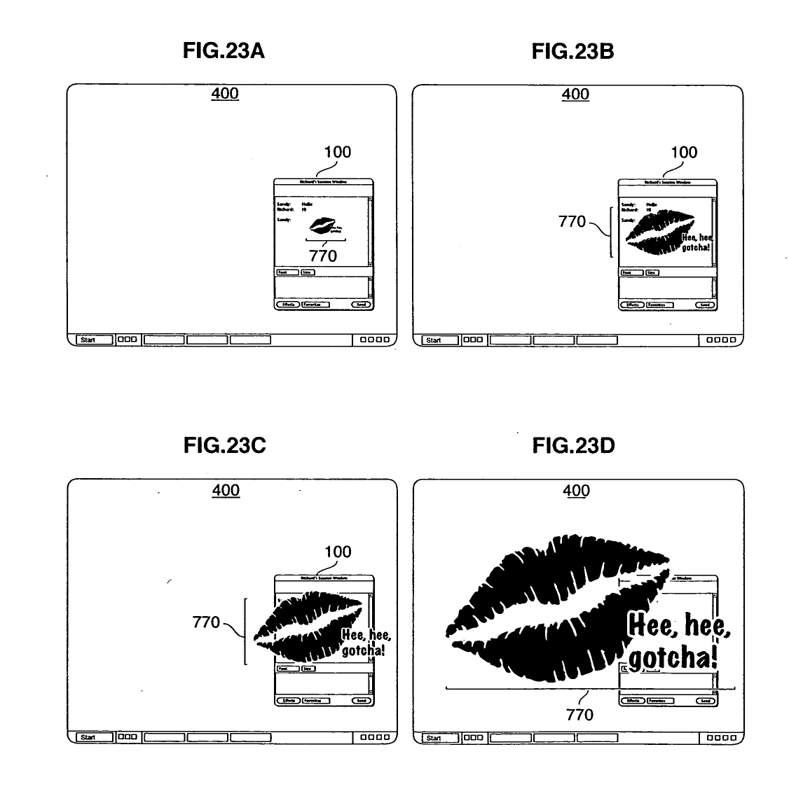

FIGS. 23A, 23B, 23C, and 23D depict, for the preferred embodiment, a presentation 770 at different sizes. In FIG. 23A the presentation 770 is small-sized and it overlays the recipient's session window 100. In FIG. 23B the presentation 770 is medium-sized and it overlays the recipient's session window 100. In FIG. 23C the presentation 770 is large-sized and it overlays the recipient's session window 100. In FIG. 23D the presentation 770 is huge-sized and it is centered on the recipient's client system screen 400.

In the preferred embodiment, the overlaid message comprising, for example, an artwork composed of outlines, e.g. line art, graphic, and text, may be suited for scaling at any size. The overlaid message comprising, for example, an artwork composed of a picture may have certain preferred scaling that typically corresponds to the size of the image instances of the picture, e.g. the picture is stored inside the artwork in two image instances: one at 128-by-128 pixels and one at 512-by-512 pixels. 128-by-128 and 512-by-512 are the preferred presentation sizes because the picture can be displayed without degradation from one of its image instances. No interpolation, the process by which an image is scaled or enlarged at the cost of its clarity, is required. The recipient's client system that possesses, for example, large computational power, e.g. a modern desktop computer, can produce high quality presentations in any size and is capable of complex image and movie interpolations. The recipient's client system that possesses, for example, limited computational power, e.g. a PDA, may produce presentations only in sizes which do not require interpolation and are smaller than a preset maximum, e.g. its screen size.

In an alternative embodiment, the sender's client and/or the host system may provide similar overlaid messages having different presentation sizes and/or having different presentation parameter settings instead of allowing for presentation scaling and/or variations.

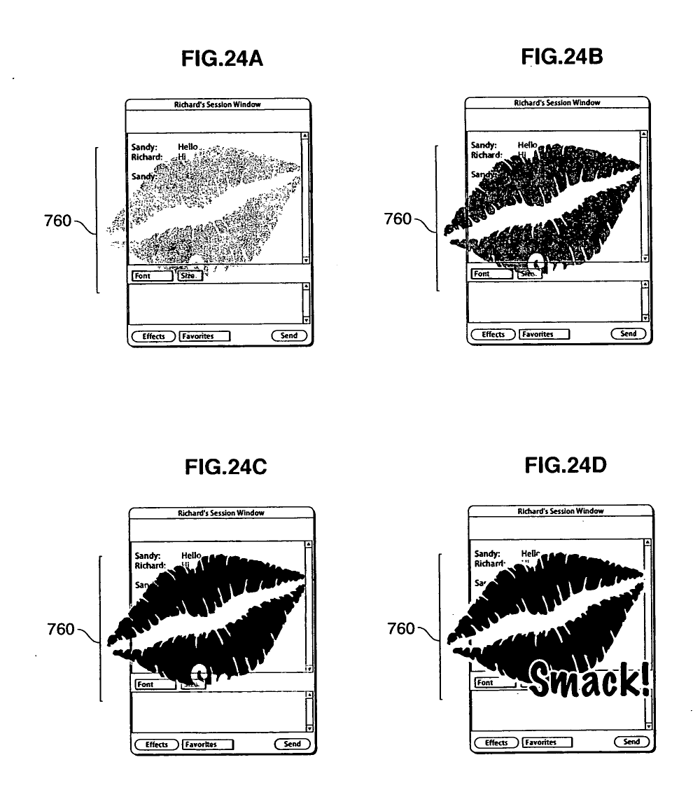

In the preferred embodiment, the presentation transparency is typically a parameter of the overlaid message. The sender's client may enable the sender to choose the presentation degree of transparency, e.g. 60%, 30%, or 0% transparency. FIGS. 24A, 24B, 24C, and 24D depict, for the preferred embodiment, a presentation 760 at different degrees of transparency. In FIG. 24A the presentation 760 has a 90% transparency. In FIG. 24B the presentation 760 has a 60% transparency. In FIG. 24C the presentation 760 has a 30% transparency. In FIG. 24D the presentation 760 has a 0% transparency.

In the preferred embodiment, a presentation may be divided into three temporal phases: an optional introductory-phase, i.e. the opening portion of the presentation; a main-phase, i.e. the main portion of the presentation; and an optional dismissal-phase, i.e. the closing portion of the presentation. Usually, the introductory-phase is played once; the main-phase is either static, played, or played in loops; and the dismissal-phase is played when the presentation terminates. Some or all of the presentation phases may be present in the overlaid message, or the recipient's client may simulate some or all of the presentation phases, for example, as the result of a process, e.g. graphic and/or sound processing, applied to the artwork and/or text.

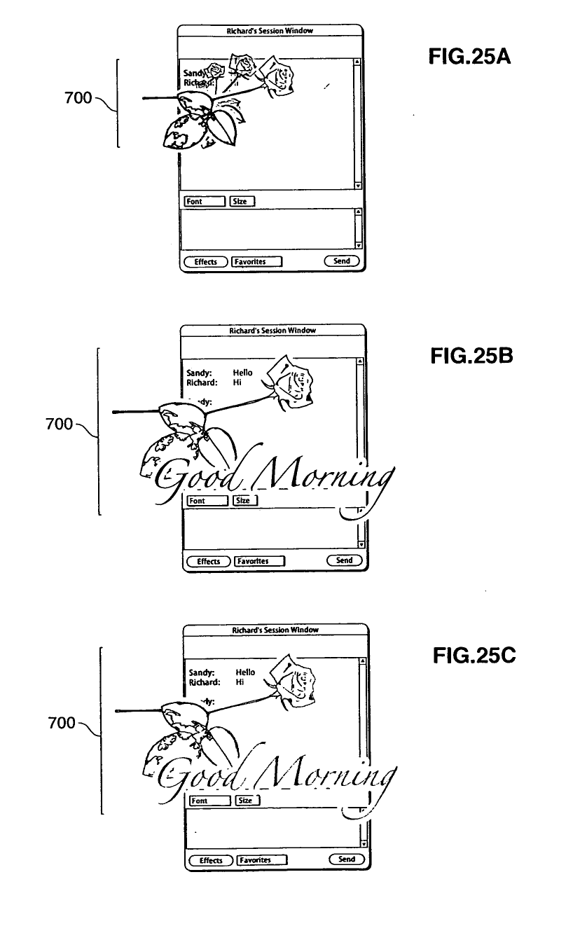

FIGS. 25A, 25B, and 25C depict, for the preferred embodiment, a presentation 700 along the three temporal phases. The artwork of the overlaid message is a rose animation along with a romantic sound. The text says “Good Morning.” In FIG. 25A, the presentation is in its introductory-phase. The presentation 700 is animating the rose that now zooms in from the recipient's session window. In FIG. 25B, the presentation is in its main-phase. The presentation 700 is animating the rose that now moves as in a breeze. The text is now visible. A romantic tune is playing along with the animation. In FIG. 25C, the presentation is in its dismissal-phase. The presentation 700 is displaying the rose and the text that are now fading out of sight.

In the preferred embodiment, some overlaid messages can have a more sophisticated presentation than others, e.g. length of animation time and/or richness of content. The sophistication of the presentation can vary greatly among overlaid messages. For example, a presentation with low sophistication may have only a main-phase displaying a static graphic, and no introductory-phase or dismissal-phase; a presentation with high sophistication may be a 3D animation having a complex introductory-phase, an animation and a sound track playing in loops during the main-phase, and a rich dismissal-phase. It is also worth noticing that the outline artwork, e.g. static or animated line art, graphics, and text, typically has the advantage of being both well scalable in size and of small load in data transmission, e.g. 5 to 50 KB, compared to other artwork formats, e.g. images or movies, that may not scale as well and may require larger data transmission, e.g. 30 to 300 KB.

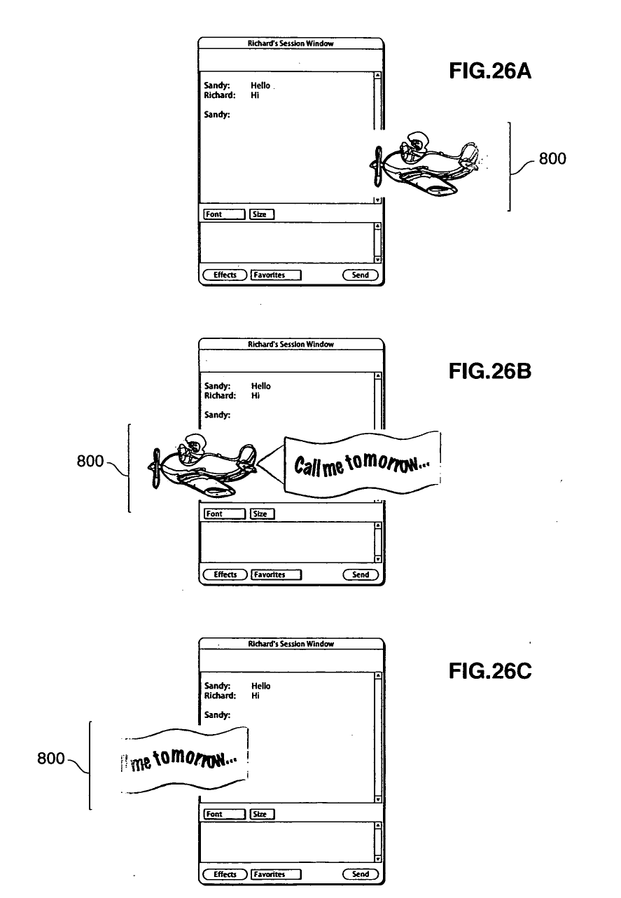

FIGS. 26A, 26B, and 26C depict, for the preferred embodiment, a presentation 800 during its main-phase, which is continuously played in loops. Both the introductory-phase and the dismissal-phase are not implemented in this presentation. When the presentation is dismissed, the main-phase finishes playing the current loop and the presentation ends. The artwork of the overlaid message is an animated toy airplane towing a banner that displays the sender supplied text “Call me tomorrow . . . .” In FIG. 26A, the presentation is at the beginning of the main-phase. The presentation 800 is moving into sight from the area just right of the recipient's session window. In FIG. 26B, the presentation is at the middle of the main-phase. The presentation 800 is fully visible. In FIG. 26C, the presentation is at the end of the main-phase. The presentation 800 is moving off sight in the area just left of the recipient's session window.

In an alternative embodiment, some or all of the presentation phases may be present in the artwork, or some of the presentation phases may be simulated by the sender's client and/or host system, i.e. instead of being simulated by the recipient's client, for example, as the result of a process, e.g. graphic and/or sound processing, applied on an artwork and/or text. In an alternative embodiment, the presentation may comprise any number of phases or even none at all.

For some particular overlaid messages, the content of the presentation and/or reminder may be in relation to a parameter automatically set by the sender system, the client system, the host system, and/or a 3rd party system. For example, one of these particular overlaid messages might represent the local weather for the sender and generate a presentation displaying a sun during good weather, a thunderstorm during bad weather, or snowflakes when it's snowing. Other examples might be an overlaid message that generates a presentation displaying content related to the daily horoscope for the sender or the receiver, or an overlaid message that generates a presentation displaying content related to the current time, date, or stock value.

In the preferred embodiment, the user can dismiss a presentation. Once requested to dismiss, the presentation may play the dismissal-phase, i.e. the closing portion of the message, and subsequently disappear, i.e. be no longer visible to the user. Once dismissed, only a reminder may still be visible. The overlaid message may also be preset, or set by the sender, to be automatically dismissed after few seconds. The recipient's client may enable the recipient to dismiss the overlaid message after it has been received and presented, e.g. to clean up the recipient's client system screen and avoid unnecessary clutter, or before it has been fully received or presented, e.g. to prevent a disliked overlaid message from being received, or simply to conserve bandwidth.

In the preferred embodiment, the recipient's client may automatically dismiss the incoming overlaid message before it has been fully received, or once it has been received. It does so upon the occurrence of a predetermined event, for example, the passage of a predetermined length of time from the reception of the overlaid message, the passage of a predetermined length of time once a new message has been received, or the class of the overlaid message being a positive, or negative, match to values set by the recipient. The recipient's client may also automatically dismiss the incoming overlaid message when the recipient's client is not the foreground application or when the overlaid message does not belong to the foreground IM session. The recipient's client may automatically, for example, delay the presentation of incoming overlaid message while a presentation is already playing and/or may play multiple presentations at once. The recipient's client may enable the recipient to customize, e.g. set or reset, some or all of the overlaid message's automatic dismissing features, for example, per overlaid message, per overlaid message classification, per IM session, per sender, or always.

In the preferred embodiment, an overlaid message may also be presented by the sender's client, for example, to enable the sender to preview the presentation before sending the overlaid message and/or, during or after sending the overlaid message, to let the sender enjoy the same, or a similar, presentation enjoyed by the recipient. Also, a simulated presentation may be shown in a preset area of the sender's session window to show the overlaid message that is in preparation for sending, e.g. the sender has chosen the overlaid message but has not sent it yet.

The following description focuses on some important alternative embodiments for overlaid messages presentation.

In an alternative embodiment, a portion, or all, of the recipient's client user interface may be transiently cleared, e.g. covered with white or another color, to let the presentation be partially or fully contained within the cleared area.

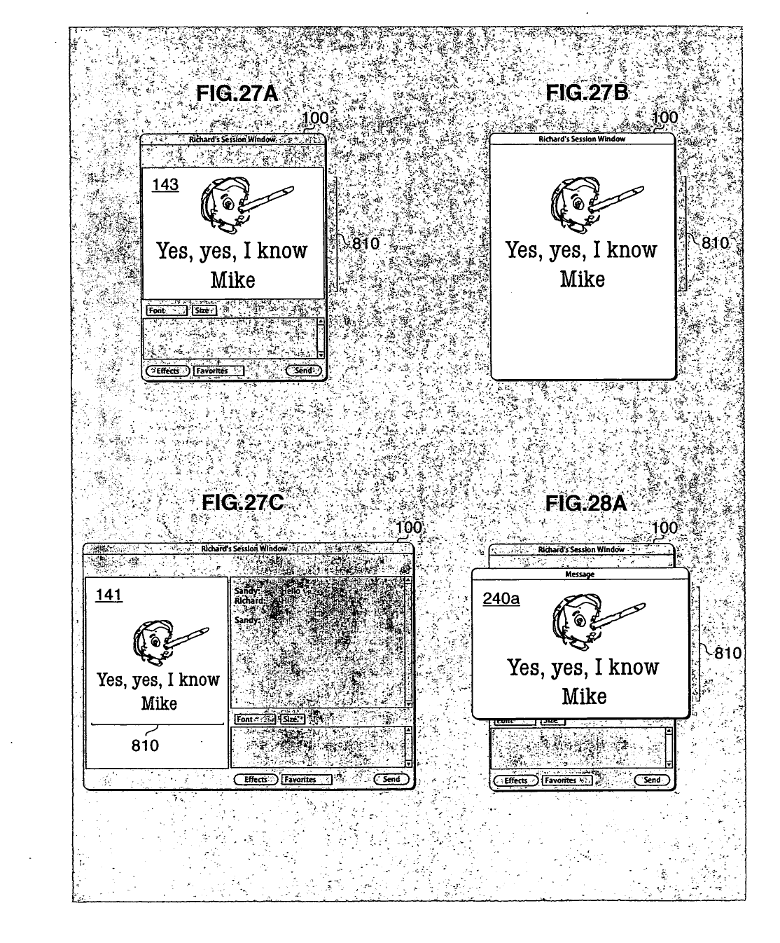

FIGS. 27A depicts, for an alternative embodiment, a presentation 810 that takes place in the recipient's session window 100 within the transcript area 143 that has been transiently cleared, e.g. covered with white or another color, for example, only for the purpose of containing presentations, or also for the purpose of containing presentations.

FIGS. 27B depicts, for an alternative embodiment, a presentation 810 that takes place in the recipient's session window 100. The recipient's session window 100 has been transiently cleared, e.g. covered with white or another color, for example, only for the purpose of containing presentations, or also for the purpose of containing presentations.

FIGS. 27C depicts, for an alternative embodiment, a presentation 810 that takes place in the recipient's session window 100 within an area 141 that has been reserved, for example, only for the purpose of containing presentations, or also for the purpose of containing presentations. The session window 100 may have been transiently expanded to reveal the area 141, e.g. the session window 100 may have looked like the session window 100 of FIG. 27A before the transient expansion.

In an alternative embodiment, the recipient's client may open, or use a separate window, e.g. away from, close to, or overlaid on the recipient's session window, to contain the presentation.

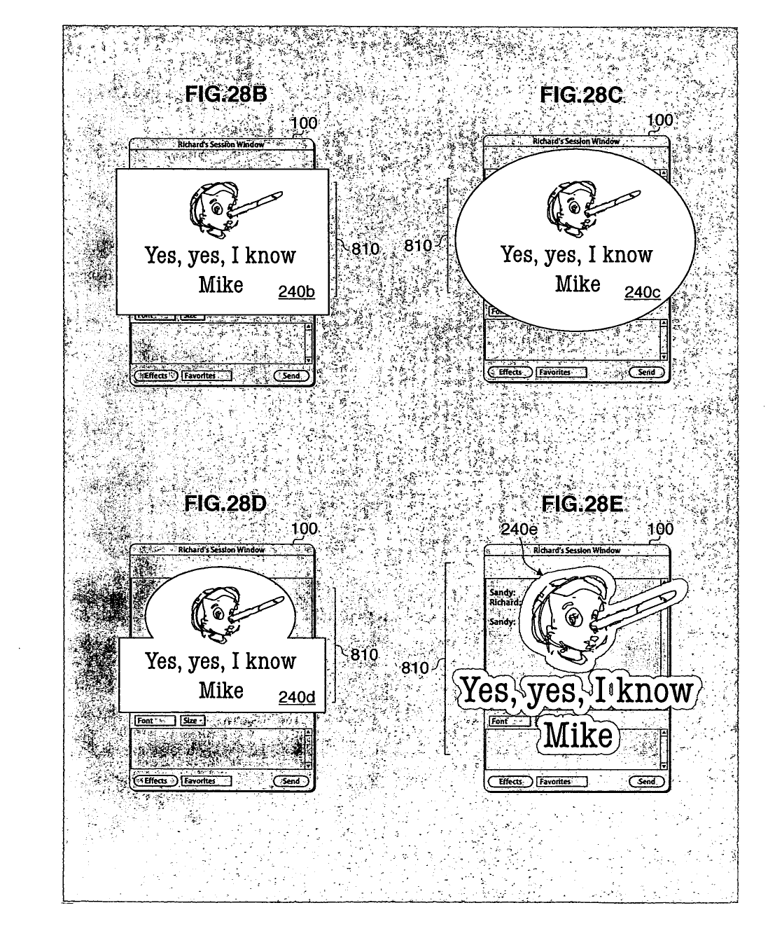

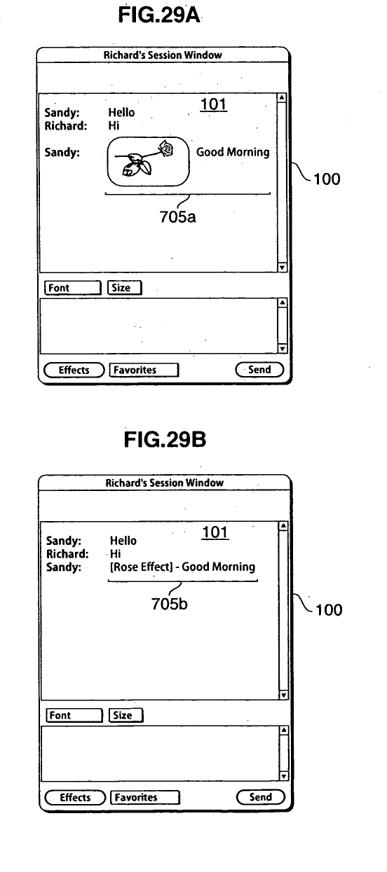

FIGS. 28A depicts, for an alternative embodiment, a presentation 810 that takes place within a window 240 that is transiently displayed in front of the recipient's session window 100. The window 240 is meant to contain only, or also, presentations. FIGS. 28B, 28C, 28D, and 28E depict, for an alternative embodiment, a presentation 810 that takes place within a window, respectively 240b, 240c, 240d, and 240e that is transiently displayed in front of the recipient's session window 100. The shapes of the windows in the figures are progressively more complicated to produce. In FIG. 28B the window 240b has a rectangular shape. In FIG. 28C the window 240c has an oval shape. In FIG. 28D the window 240d has a composite shape made by oval for the artwork and a rectangle for the text. In FIG. 28E the window 240e has a shape that follow the contour of the overlaid message.

In an alternative embodiment, a portion, or all, of the recipient's client user interface may be reserved to contain the presentation. In an alternative embodiment, the recipient's session window, or any of the windows of the recipient's client user interface, may expand to contain the presentation. In an alternative embodiment, the overlaid message may be presented contained in a preset window of the recipient's client user interface.

The following description focuses on the overlaid messages reminder.

In the preferred embodiment, the overlaid message may be inserted as a reminder in the transcript, e.g. displayed in the transcript area, of the sender's session window or in any preset area of the sender's client user interface. Similarly, the overlaid message may be inserted as a reminder in the transcript of the recipient's session window and/or any preset area of the recipient's client user interface. The reminder may be static or animated and may assume the form of, for example, text, icon, alternative size of the associated overlaid message itself, or something reminiscent, or not reminiscent, of the associated overlaid message. It is usually sized small enough to fit in the transcript of the user's session window without occupying much more space than a regular textual IM.

FIG. 29A depicts, for the preferred embodiment, a reminder 705a that is displayed in the transcript area 101 of the session window 100. The reminder 705a comprises an iconic artwork and text. FIG. 29B depicts, for an alternative embodiment, the reminder 705b that is displayed in the transcript area 101 of the session window 100. The reminder 705b comprises a textual description of the artwork and the text.

In the preferred embodiment, the recipient's client may enable the recipient to select the reminder, for example, to have the associated overlaid message be presented or presented again on the recipient's client system screen. Similarly, the sender's client may enable the sender to select the reminder, for example, to have the associated overlaid message be presented or presented again on the sender's client system screen.

The following description focuses on the overlaid messages feedback.

In the preferred embodiment, when the transmission of an overlaid message begins, a statement may be inserted in the transcript of the sender's session window. The statement may display the reminder of the transmitted overlaid message. The statement may also display one or more progress indicators of the delivery, e.g. progress bar, mark, icon, text note, or combination of them. Once the recipient's client starts its presentation, the statement in the transcript of the sender's session window may display one or more progress indicators of the presentation, e.g. progress bar, mark, icon, text note, or combination of them. To give feedback of the progression of the transmission and/or presentation, the sender's client may also play sound clues, e.g. one sound when the presentation begins, and another sound when the presentation ends.

In the preferred embodiment, when the transmission of the overlaid message begins, a statement may be inserted in the transcript of the recipient's session window. The statement may display one or more progress indicators of the delivery, e.g. progress bar, mark, icon, text note, or combination of them. The statement may also display the reminder of the transmitted overlaid message. The reminder may be masked to preserve the overlaid message's emotional impact until the overlaid message is presented, e.g. the reminder may be covered by a gift wrapping pattern, blanked out, or grayed out.

In an alternative embodiment, the sender's client may notify the sender of the progress of an overlaid message transmission and/or the progress of its subsequent presentation using one or more items, e.g. progress bar, mark, icon, text note, or combination of them, displayed or flashed in the sender's client user interface. In an alternative embodiment, the recipient's client may inform the recipient of the incoming overlaid message and/or its transmission progress using one or more items, e.g. progress bar, mark, icon, text note, or combination of them, displayed or flashed in the recipient's client user interface.

In an alternative embodiment, a reminder may be shown in a preset place in the sender's client user interface before and/or while the associated overlaid message is sent. In an alternative embodiment, a reminder is inserted in the transcript of the sender's session window as soon as the associated overlaid message is sent, yet the reminder is inserted in the transcript of the recipient's session window only when the associated overlaid message has been received and/or has finished its presentation. In an alternative embodiment, a reminder is inserted in the transcript of the sender's session window and in the transcript of the recipient's session window at the same time when the associated overlaid message is sent.

In an alternative embodiment, as an extra feature, the sender's client may enable the sender to send an unannounced overlaid message, e.g. no associated reminder is placed in the transcript of the recipient's session window until the overlaid message has been presented, and no information of the overlaid message being delivered is presented to the recipient. The recipient's client may provide a feature to force the revealing of incoming unannounced overlaid messages, e.g. the recipient's client treats an unannounced overlaid message as a regular one; no transmission hiding of incoming overlaid messages.

The following description focuses on the user's client system capabilities.

In the preferred embodiment, on the user's client system lacking sufficient hardware or software features, e.g. little computational power, small screen size, or limited operating system support, the user's client may be prevented from producing a fully featured presentation. Such user's client system may lack the capability to support one or more presentation features, for example, overlaying the user system screen, being semi-transparent, growing, shrinking, moving, jumping, or changing its degree of transparency, shape, or content. In such cases, the user's client may produce a partial presentation, e.g. the presentation is shown in accordance with the feature supported by the user's client system, or the user's client may not produce the presentation at all, and, for example, notify the user of the occurrence, e.g. insert a warning message in the transcript of the user's session window, display a text note, or play a sound clue. Examples of the user's client systems that lack sufficient hardware or software features are desktop computers running older operating systems, e.g. Apple Computer Inc., Mac OS 8, Microsoft Inc., Windows 3.1, or Microsoft Inc., Windows 95; PDAs, e.g. a Palm One Inc., Palm 505 running Palm OS 5, or, so called, smart cell phones, e.g. a Fujitsu Ltd., F900iC running Symbian Ltd., Symbian OS.

In the preferred embodiment, the sender's client may be notified, by the recipient's client and/or by the host system, of the recipient's client system capabilities to receive in a timely manner, e.g. the delivery is estimated to take longer than a preset time, or to present properly, i.e. perform a presentation, overlaid messages, e.g. the recipient's client system uses a narrowband modem connection and can receive, in a timely manner, only lightweight overlaid messages, the recipient's client system is a PDA device and can produce only small-sized presentations, or the recipient's client system is an older desktop computer that can smoothly present only simple overlaid messages.

The sender's client user interface may display an item, e.g. a mark, icon, or text note, near each buddy in the sender's buddy list window indicating the buddy's capabilities to receive in a timely manner, or properly present, overlaid messages. Also, the sender's session window may display an item, e.g. a mark, icon, or text note, indicating the recipient's, or recipients', capabilities to receive in a timely manner, or properly present, overlaid messages.

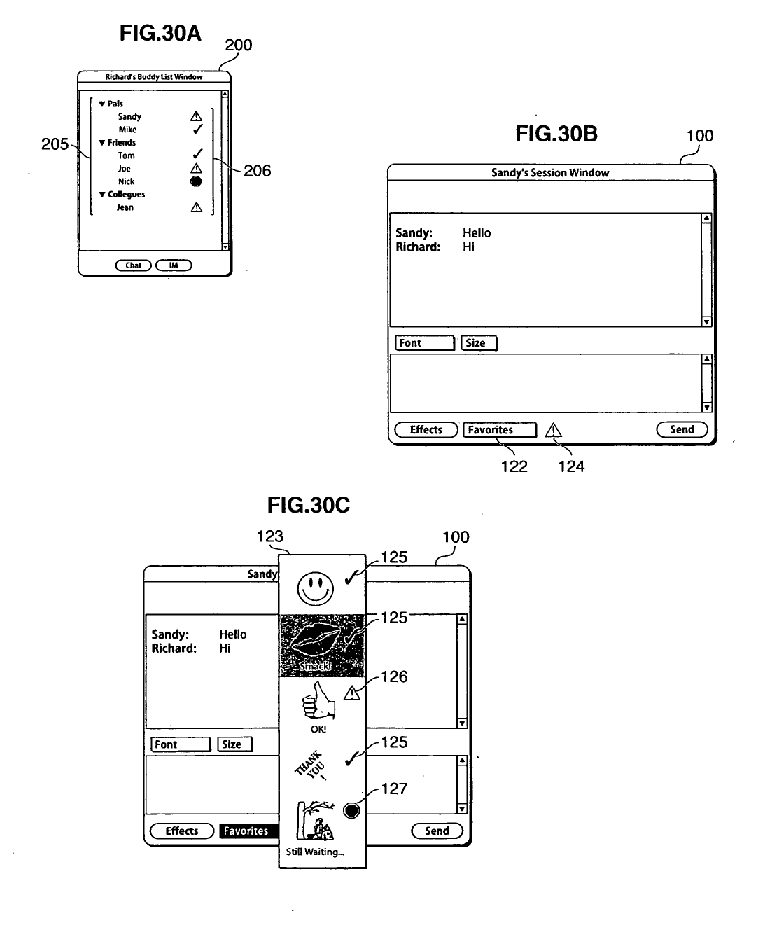

FIG. 30A depicts, for the preferred embodiment, the sender's buddy list window 200 displaying next to the buddies 205 the buddy reception and presentation capability marks 206. For example, a check mark indicates full capability to receive in a timely manner, and properly present, overlaid messages, a warning-sign icon indicates partial capability to receive in a timely manner, or properly present, overlaid messages, a stop-sign icon indicates no capability to receive in a timely manner, or properly present, overlaid messages.

FIG. 30B depicts, for the preferred embodiment, the sender's session window 100 displaying, next to the favorites popup control 122, a warning-sign icon 124 indicating that the recipient has, for example, partial capability to receive in a timely manner, or properly present, overlaid messages.

In the preferred embodiment, the sender's client user interface may display a warning signal when the sender attempts to send an overlaid message which cannot be presented at its best on at least one of the recipient's client systems, e.g. the presentation is not played smoothly on one of the recipient's client systems because it lacks sufficient computational power, or the message is not completely visible on one of the recipient's client systems because its screen is too small. On such occurrence, the sender's client may, for example, present the sender with one or more alternative solutions, e.g. to send a less complex overlaid message, to deliver the overlaid message only to the subset of capable recipient's client systems, to set the overlaid message to be presented small-sized, or to abort the attempt altogether.

In the preferred embodiment, the sender's client user interface may display a warning signal when the sender attempts to send an overlaid message which cannot be delivered in a timely manner to at least one of the recipient's client systems, e.g. one of the recipient's client systems is connected through a narrowband modem connection or narrowband wireless connection. On such occurrence, the sender's client may, for example, present the sender with one or more alternative solutions, e.g. to send a lighter-weight overlaid message, to deliver the overlaid message only to the subset of recipient's client systems having a capable connection, to asynchronously deliver the overlaid message, or to abort the attempt altogether.

In the preferred embodiment, when the sender selects from a repository, the sender's client user interface may, for example, display an item, e.g. a warning mark, icon, text note, or combination of them, near overlaid messages that cannot be presented at their best on the recipient's client systems. For example, the maximum size at which the presentation can take place may be displayed near overlaid messages that cannot be presented at their best. Also, when the sender selects from a repository, the sender's client user interface may, for example, display an item, e.g. a warning mark, icon, text note, or combination of them, near overlaid messages that cannot be delivered in a timely manner to the recipient's client systems. For example, the estimated delivery time may be displayed near overlaid messages that cannot be delivered in a timely manner.

FIG. 30C depicts, for the preferred embodiment, the sender's session window 100 while the sender is selecting from the favorites menu 123. Next to each overlaid message item contained in the favorites menu 123 is displayed a reception and presentation capability mark 125, 126, and 127 indicating the recipient reception and presentation capability for a specific overlaid message. For example, the check mark 125 indicates full capability to receive in a timely manner, and properly present, the overlaid message next to the check mark; the warning-sign icon 126 indicates partial capability to receive in a timely manner, or properly present, the overlaid message next to the check mark; the stop-sign icon 127 indicates no capability to receive in a timely manner, or properly present, the overlaid message next to the check mark.

In an alternative embodiment, the sender's client may be notified, by the recipient's client and/or by the host system, of the recipient's client system characteristics, i.e. instead of its capabilities to receive in a timely manner, or properly present, overlaid messages, for example, its computational power, its screen size, and/or the available bandwidth of its communication channel. In an alternative embodiment, the sender's client user interface may display an item, e.g. a mark, icon, or text note, near each buddy in the sender's buddy list indicating the buddy's system characteristics. Also, the sender's session window may display an item, e.g. a mark, icon, or text note, indicating the recipient's, or recipients', client system characteristics.

In an alternative embodiment, the sender's client may enable the sender to select, from a repository, only the overlaid messages that can be presented at their best on, or delivered in a timely manner to, the recipient's client systems, e.g. an unsuited overlaid message may be hidden from the repository or may be dimmed and not selectable.

The following description focuses on the transmission of overlaid messages.

In the preferred embodiment, when participating in a multi-user communication, e.g. a chat room, the sender's client may enable the sender to send the overlaid message to all recipients, e.g. user A, B, and C are present in the chat room. User A sends the overlaid message to both user B and user C. Both user B and user C receive the overlaid message. The sender's client may also enable the sender to send the overlaid message to a chosen subset of all the recipients, e.g. user A, B, and C are present in the chat room. User A sends the overlaid message to user B only. User B receives the overlaid message, and user C does not.

In the preferred embodiment, the transmission of an overlaid message may follow different strategies depending on the type of connection, e.g. point-to-point or server intermediated, and data caching model, e.g. the data of the overlaid message is cached on the recipient's client and/or on the host system. For example, the whole data necessary to present the overlaid message may be transmitted from the sender's client to the recipient's client, part of the data may be transmitted from the sender's client and the rest of the data is supplied by the recipient's client and/or the host system, or the whole data needed to present the overlaid message may be supplied by the recipient's client and/or the host system upon request from the sender's client. Furthermore, the sender's client may communicate directly with the recipient's client or the communication may pass through, and/or be intermediated by, the host system.

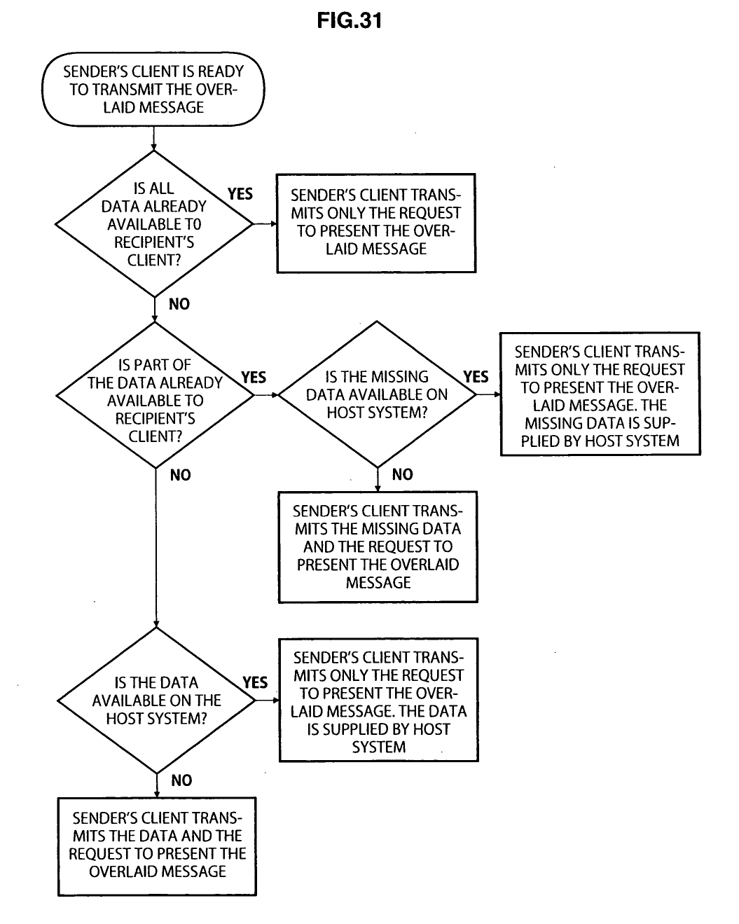

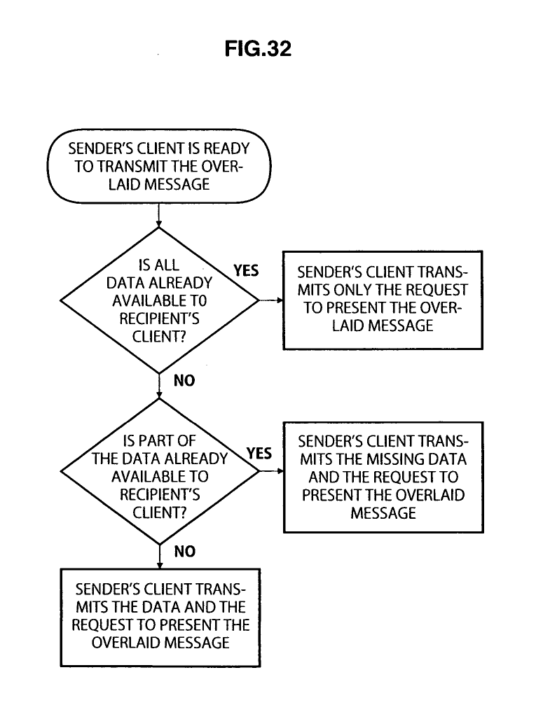

FIGS. 31 and 32 show, for the preferred embodiment, flow-charts of the transmission algorithms. FIG. 31 refers to a host system intermediated communication and FIG. 32 to a direct client-to-client communication. The term “data” refers to the data of the overlaid message.

In the preferred embodiment, the transmission of the overlaid message may use the whole communication capability of the sender's client and/or of recipient's client, e.g. other communications are stopped while the overlaid message is transmitted, and the IM conversation is temporarily halted, or the transmission of the overlaid message may use only part of the communication capabilities of the sender's client and of recipient's client, e.g. other communications can be carried on while the overlaid message is transmitted, and the IM conversation can progress. In the latter case, the sender's client may allow the sender to send the overlaid message asynchronously to enable both the sender and the recipient to exchange regular IMs, e.g. text messages, and/or send other overlaid messages, while the overlaid message is being delivered.

In the preferred embodiment, the transmission of the overlaid message may use well-known data transmission techniques. The sender's client may transmit data to the recipient's client, with or without host system intermediation or relay, splitting and encapsulating messages in one or more packets that are binary, ASCII, Base64, or otherwise encoded. The packet also contains a header that tags the encapsulated data. This encapsulation process may be used to enable intermixed transmission of textual IMs, overlaid messages, and any type of data as long as the packet header is properly tagged to identify the data carried. The sender's client may send a textual IM, i.e. the data of the textual IM, which is split in one or more packets tagged as text, and send an overlaid message, e.g. all, or part, of data of the overlaid message, or its ID, which is split in one or more packets tagged as overlaid messages. The recipient's client recognizes the different types of packets received, and, for example, display the textual IM or present the overlaid message. When the sender's client transmits only part, or none, of overlaid message data, the host system uses the same encapsulation process to supply the remaining portion of it to the recipient's client.

The following description focuses on the filtering of overlaid messages. In the preferred embodiment, the sender's client and/or the host system may apply a filter to prevent an overlaid message from being transmitted. The recipient's client and/or the host system may apply a filter to prevent an overlaid message from being received and/or presented. Filtering may be used, for example, to implement a parental policy, e.g. to allow sending and/or receiving only certain classes of overlaid messages. Filtering may also be used, for example, to stop overlaid messages that violate the service user agreement policy.

In the preferred embodiment, during the transmission, the sender's client and/or the host system may, under certain circumstances, substitute a transmitted overlaid message with an alternative one. For example, some of the recipient's clients may not be connected through a communication channel capable of prompt delivery of the overlaid message, e.g. a narrowband modem connection. The sender's client and/or the host system may therefore deliver to the recipient's client a lightweight substitute of the original overlaid message. During the transmission, the sender's client, the recipient's client, and/or the host system may, under certain circumstances, substitute a transmitted overlaid message with a regular IM, e.g. a text message, that says, for example, that the overlaid message has been sent but not received. This might happen, for example, when the recipient's client is unable to properly handle the overlaid message, e.g. the recipient's client is an older software built before this invention, or the recipient's client belongs to a different IM service provider that does not have the rights to this invention. Another circumstance in which the transmitted overlaid message may be substituted with an alternative one, or with a regular IM, occurs when unusual conditions require it, e.g. to conserve the communication channel's bandwidth, or the server's processing power, during abnormally high service usage or during system malfunctions.

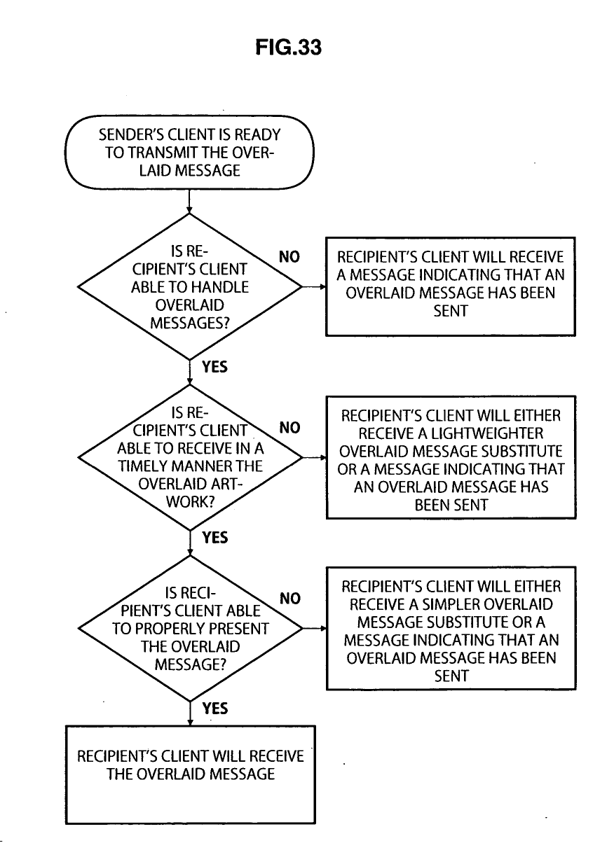

FIG. 33 shows, for the preferred embodiment, a flow-chart of the substitution algorithm.

The following description focuses on the user operations.

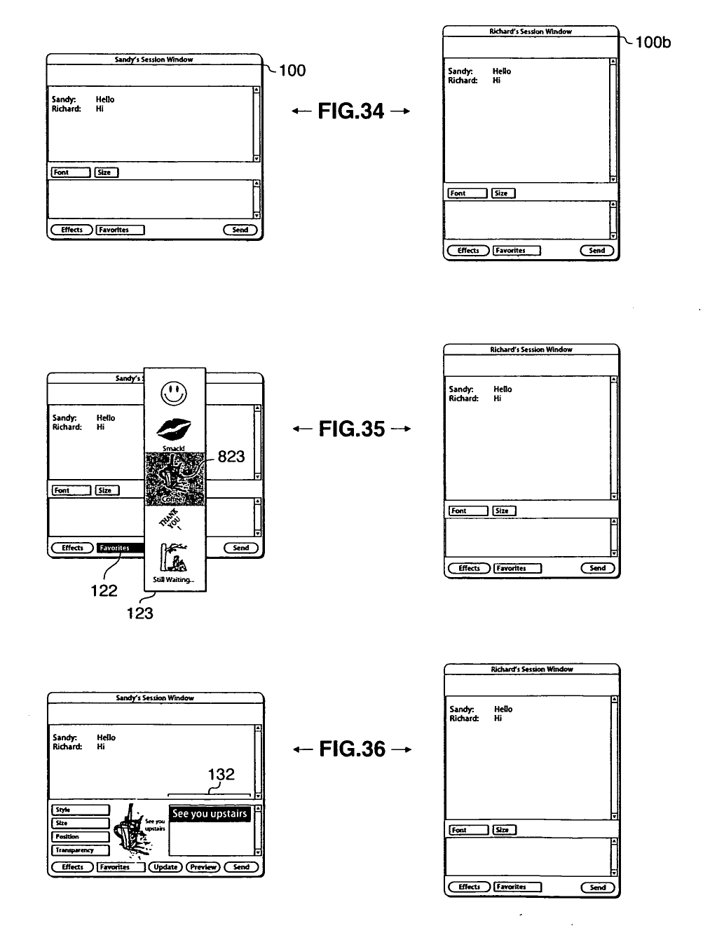

The following description focuses on the user operations showing the sequence that two fictional users, Sandy and Richard, perform to exchange overlaid messages. FIGS. 34 through 44 depict, for the preferred embodiment, Sandy's session window 100 and Richard's session window 100b. The first overlaid message is sent from Sandy to Richard. It is a fairly complex overlaid message Its presentation comprises all the three presentation phases. Sandy selects it from her repository of favorites, edits the overlaid message text, and sends it to Richard. Being a complex overlaid message of a few hundred kilobytes, it takes few seconds to be delivered over a broadband connection. During the time in which the complex overlaid message is delivered and presented, Sandy has feedback of the delivery and presentation progression. After enjoying the presentation, Richard decides to exchange the pleasure and sends an overlaid message to Sandy. He inputs the text and then selects a simple overlaid message by means of a shortcut. Richard has set his client to send that particular overlaid message automatically once he chooses it, without need of any further action. Being a simple overlaid message of few kilobytes, it is delivered almost instantaneously. Richard has feedback of the delivery and presentation progression.

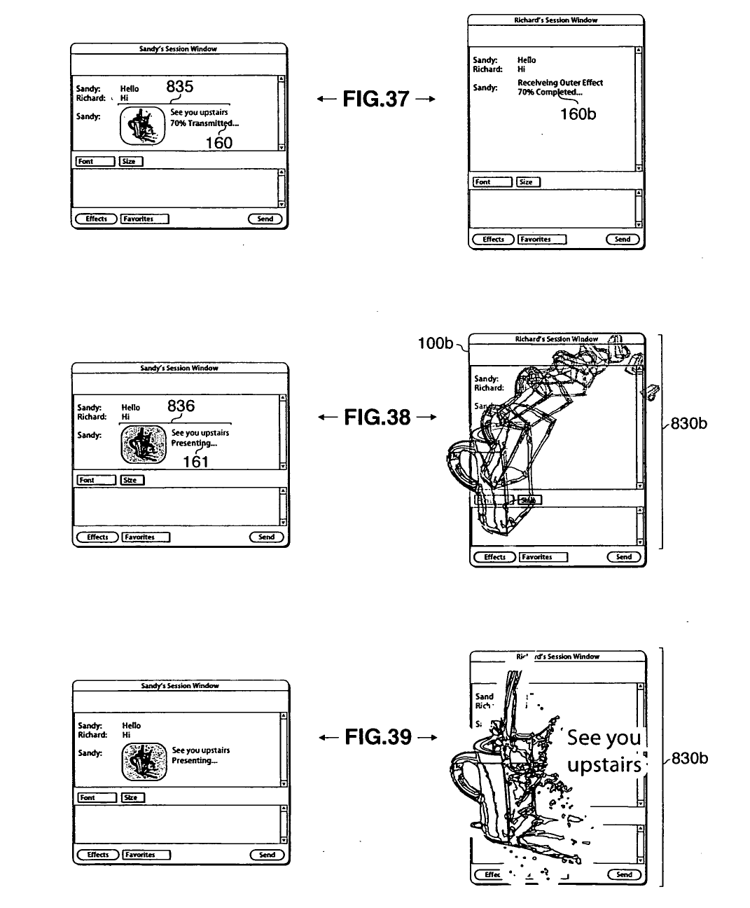

FIGS. 34, 35, 36, and 37 depict the session windows during the selection and delivery of the first-to-be-exchanged overlaid message. In FIG. 34, the users have not exchanged any overlaid message yet. In FIG. 35, Sandy is choosing the overlaid message item 823 from her favorites menu 123 that she accesses by clicking on the favorites popup control 122. In FIG. 36, Sandy is editing the overlaid message text using the text composition area 132. In FIG. 37, the overlaid message that Sandy has chosen and edited is being transmitted to Richard's client. A statement is inserted in Sandy's transcript. The statement is displaying the reminder 835 and the transmission progress notification 160. A statement is also inserted in Richard's transcript. His statement is displaying the progress notification 160b, without revealing the content of the transmitted overlaid message.

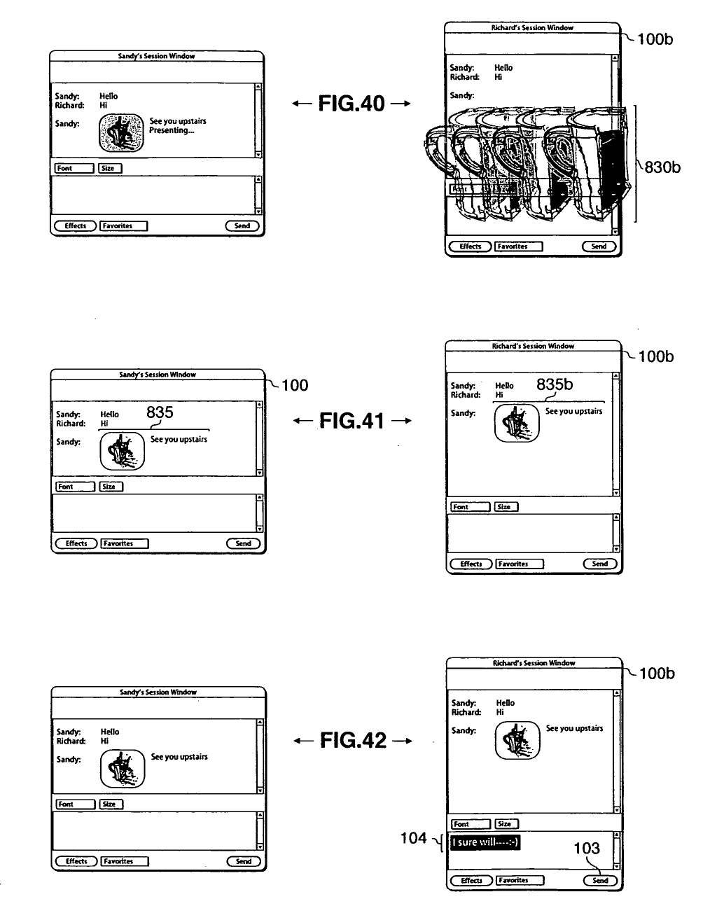

FIGS. 38, 39, and 40 depict the session windows while Richard's client is playing the presentation 830b. Sandy's transcript is showing the highlighted reminder 836, highlighted to emphasize that the overlaid message is being presented, and the presentation progress notification 161. In FIG. 38, Richard's presentation 830b is playing its introductory-phase in which an animated half-cup of coffee is thrown out of Richard's session window 100b. In FIG. 39, Richard's presentation 830b is playing its main-phase in which animated coffee continues pouring into the half-cup. In FIG. 40, Richard has requested the dismissal of the overlaid message, and the presentation 830b is playing its dismissal-phase in which the animated half-cup of coffee is moving away from Richard's session window 100b.

FIG. 41 depicts the session windows after the overlaid message has been fully dismissed. What is now displayed of the overlaid message on Sandy's session window 100 is only the reminder 835, and on Richard's session window 100b is only the reminder 835b. It is noticeable that, even if the presentation was large-sized, the reminder is small-sized and does not use much space in either transcript. Even if they are distracted by other tasks, both users can instantly recall the point of communication by quickly re-reading their uncluttered transcript.

FIGS. 42, 43, and 44 depict the session windows during the second overlaid message exchange. In FIG. 42, Richard inputted the string 104, “I sure will----:-)” which comprises the text “I sure will” and the two sub-strings “----” and “:-)” which on his instant messenger client in this combination, the first sub-string selects an medium-sized overlaid message and the second sub-string chooses the artwork “smiley” to be used in the overlaid message. In this example, the user has his client set to automatically send overlaid messages generated by textual input once he selects the send button 103, without need to take further actions.

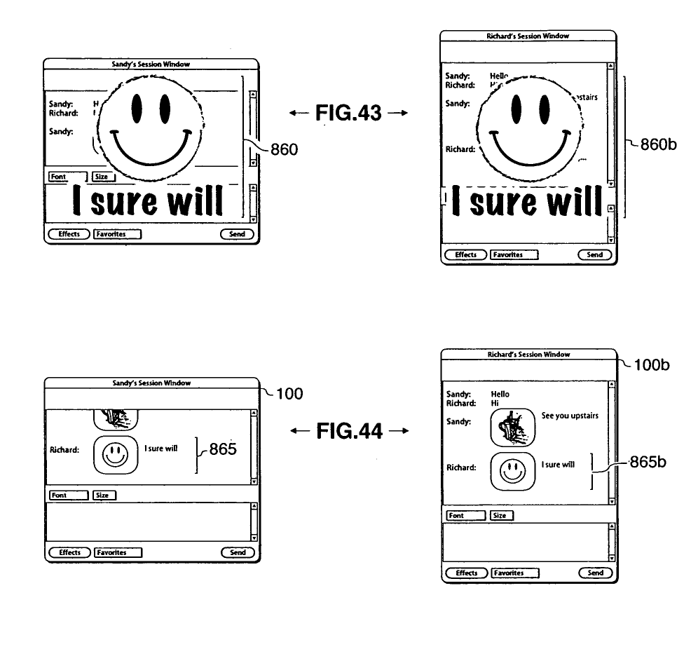

In FIG. 43, Sandy's client is displaying the presentation 860, a “smiley”, because she just received the overlaid messages that generates it. Richard's transcript is displaying the presentation 860b, a “smiley”, because he has set his instant message client to display a full sized feedback presentation of the overlaid messages he sends. The presentation 860b may start at a similar time of the presentation 860, e.g. due to network latencies, and it may terminate at a different time than the presentation 860, e.g. Richard requests to dispose the presentation 860b before Sandy requests to dispose the presentation 860.

In FIG. 44, the overlaid message has been fully dismissed. What is now displayed of the overlaid message on Sandy's session window 100 is only the reminder 865, and on Richard's session window 100b is only the reminder 865b. Even more noticeable now is the advantage provided by small-sized reminders that do not use much space in transcripts.

The following description focuses on overlaid messages interjected in the communication by 3rd parties.

In the preferred embodiment, a 3rd party, e.g. an entity not otherwise involved in the communication between the users, may send to some or all of the user involved in the communication session one or more overlaid messages. For example, an instant message service provider might use this feature for the delivery of breaking news, information, or advertisements. An interjected overlaid message may not be shown as a reminder in the transcript.

In case an interjected overlaid message is used for an advertisement, the choice of the advertisement category, e.g. bicycle products, soaps, shoes, etc., may be the result of an analysis of the communication content performed by 3rd parties, for example, on per user, per session, or other basis.

Although the invention has been described herein with reference to instant message clients having textual capabilities, one skilled in the art will readily appreciate that other types of clients may be substituted for those set forth herein without departing from the spirit and scope of this invention. For example, clients that may be substituted for instant message clients comprise streaming or non-streaming video clients, audio clients, and multimedia clients exchanging data between users, e.g. Apple Computer Inc., iChat AV or Yahoo Inc., Messenger Webcam, or receiving data from a broadcaster, e.g. RealNetworks, Inc., RealPlayer 10 or Microsoft Inc., Windows Media Player 9; IM clients having a user interface lacking the transcript area, which, for example, display IM messages on popup windows; applications that, de facto, act in part, or in totality, as an IM client; applications which primary purpose is not to enable a user-to-user, or multi-user, communication yet enable a partial or complete form of communication, e.g. a word processor having collaborative capabilities; clients which sole, or primary, purpose is to transmit and/or present overlaid messages; e-mail clients, e.g. Microsoft Inc., Outlook Express or Apple Computer Inc., Mail 1.3.9; e-mail and/or IM clients integrated in a software package, e.g. America Online Inc., AOL 9.0, International Business Machines Corp., Lotus Notes 6.5, or Microsoft Inc., Entourage 2004; WEB browsers, e.g. Microsoft Inc., Explorer 6, Netscape Inc., Navigator 7; and communication clients for cellular phones or PDAs.

The overlaid message artworks and texts depicted and commented in this description are merely examples. Any other artwork or text may be substituted for those set forth herein without altering the substance of this invention.

Although the invention is described herein with reference to the preferred embodiment, one skilled in the art will readily appreciate that other applications may be substituted for those set forth herein without departing from the spirit and scope of the present invention. Accordingly, the invention should only be limited by the Claims included below.

1. A computer implemented method, comprising the steps of:
providing an instant messaging client application user interface for an instant messaging communications session involving at least one instant message recipient and an instant message sender;
said at least one instant message recipient receiving a communication that comprises a message to be displayed to said at least one instant message recipient; and
said message being selected by said instant message sender;
wherein said message is presented at least partially overlaid on said instant messaging client application user interface of said at least one instant message recipient and said presentation being transient in nature.

2. The method of claim 1, further comprising the step of:
said message being selected by said Instant message sender to be transiently presented at an enlarged size;

3. The method of claim 1, wherein said message is presented at least partially overlaid on said instant messaging client application user interface of said at least one instant message recipient, said presentation being transient in nature, and said presentation comprising a magnified display of at least part of the text comprised in said message.

4. The method of claim 3, said text being any of the following:
at least partially supplied by said instant message sender; and
selected by said instant message sender.

5. The method of claim 3, said text being encoded in said message in other than textual form;

6. The method of claim 5, said encoding comprising any of the following:
a reference to text;
a reference to an image depicting text;
an image depicting text;
a sequence of at least one glyph; and
a reference to a sequence of at least one glyph.

7. The method of claim 1, the length in time of said transient message presentation being determined by any of the following:
a preset timer;
a timer set by said instant message sender,
a timer set by said instant message recipient;
an explicit request of termination from said instant message recipient;
an implicit request of termination from said instant message recipient; and
an incoming message.

8. The method of claim 1, wherein said transient message presentation is semitransparent

9. The method of claim 1, wherein said transient message presentation is surrounded by a border.

10. The method of claim 9, said border comprising any of the following:
a highlighting border;
a colored border,
a white-like color border;
a shadow;
a non-linear color transformation border;
a dimming of the underling user interface; and
a transiently displayed zooming oval that introduces and briefly encompasses the presentation.

11. The method of claim 1, wherein said transient message presentation comprises a transient graphic alteration of a preexisting user interface.

12. The method of claim 1 1, said transient graphic alteration of pre-existing user interface comprising any of the following:
a water-drop-like ripple effect;
a lens-like effect;
a burn-like effect;
a hole-like effect; and
a shake-like effect.

13. The method of claim 3, said text being displayed with an artistic elaboration applied to it.

14. The method of claim 13, said artistic elaboration comprising any of the following:
each letter having a white core surrounded by a red border;
each letter having a 3D appearance;
the text having a metallic appearance;
the text having water-like colors;
the text having an embossed appearance;
a dark shadow is displayed near the text;
at least part of the text is surrounded by an embossed blue border;
each letter having a green core surrounded by a yellow border;
each letter having a green core surrounded by a yellow border and at least part of the text is further surrounded by a black border; and
each letter having a green core surrounded by a yellow border, at least part of the text is further surrounded by a black border, and a dark shadow is displayed near at least part of the text.

15. The method of claim 3, said text being displayed in an altered shape.

16. The method of claim 15, said shape alteration comprising any of the following;
at least part of the text being warped;
at least part of the text being convoluted;
at least part of the text being stretched;
at least part of the text being rotated;
at least part of the text following a wave-like path;
at least part of the text having a reflex-like display along with its primary display; and
at least part of the text being slanted and enlarged to create a protruded 3D appearance.

17. The method of claim 3, said text display being in other than Roman language letters and symbols.

18. The method of claim 3, at least one characteristic of said text display being in a preset relation to at least one artwork comprised in said transient presentation.

19. The method of claim 18, said characteristic comprising any of the following:
font type;
text size;
text display position in relation to at least one artwork;
text display position in relation to said instant messaging client application user interface;
artistic elaboration of the text displayed;
altered shape of the text displayed; and
additions to the sender supplied text.

20. The method of claim 1, said presenting step further comprising any of the step of:
providing an introductory-phase animation comprising an opening portion of said presenting step;
providing a main-phase animation comprising a main portion of said presenting step; and
providing a dismissal-phase animation comprising a closing portion of said presenting step.

21. The method of claim 1, wherein an indication is provided to said recipient that a presentation of an incoming message is being delayed until a current transient presentation ends.

22. The method of claim 1, said transient message presentation being delayed until an action of said instant message recipient is performed.

23. The method of claim 1, wherein said message is transiently presented unbound by said instant messaging client application user interface of said at least one instant message recipient.

24. The method of claim 1, wherein said message is presented within a user interface element transiently displayed at least partially overlaid on said instant messaging client application user interface of said at least one instant message recipient, and said message presentation comprises magnified display of at least part of the text comprised in said message

25. The method of claim 1, wherein said message is transiently presented magnified within said instant messaging client application user interface of said at least one instant message recipient and said presentation comprises display of at least part of the text contained in said message.

26. The method of claim 25, wherein said instant messaging client application user interface changes in shape or in size to accommodate said transient message presentation.

27. A computer implemented method, comprising the steps of:
providing an instant messaging client application user interface for an instant messaging communications session involving at least one instant message recipient and an instant message sender;
said at least one instant message recipient receiving a communication that comprises a message to be displayed to said at least one instant message recipient; and
said message Comprising at least one presentation and parameter that is selected by said instant message sender;
wherein the selection of said at least one presentational parameter of said message is effected by said sender by means of textual input.

28. The method of claim 27, said presentational parameter comprising any of the following:
the size of the presentation;
the size of the text of the presentation;
the size of at least one artwork of the presentation;
the style of the presentation;
the style of the text of the presentation;
the style of at least one artwork of the presentation;
the animation of the presentation;
the animation of the text of the presentation; and
the animation of at least one artwork of the presentation.

29. The method of claim 27, said textual input comprising any of the following:
a sequence of at least one character which length identifies the size of the presentation;
a sequence of at least one character identifying the style of the presentation;
a sequence of at least one character identifying the animation of the presentation;
a sequence of at least one character comprising an identifier of the size of the presentation;
a sequence of at least one character comprising an identifier of the style of the presentation;
a sequence of at least one character comprising an identifier of the animation of the presentation; and
a sequence of at least one character comprising an identifier of at least one artwork to be comprised in the presentation.

30. The method of claim 27, wherein the selection of at least one presentational parameter of said message is within a set of at least one possible choice preselected by said sender.

31. The method of claim 30, said possible choices comprising any of the following:
any presentation size within a preset minimum and maximum;
any presentation style among a set of styles;
any text style among a set of similar styles;
any artwork among a set of artworks;
any artwork among a set of similar artworks;
any animation among a set of animations;
any animation among a set of similar animations;
any speed for a drop-like animations within a preset minimum and maximum; and
any type of typewriter-like animations within a preset group.

32. The method of claim 27, wherein the selection of at least one presentational parameter of said message is at least partially derived from the content of said message.

33. The method of claim 32, said selection comprising any of the following:
said text having only one word selects a large size presentation;
said text comprising the word “yes” selects a green-like color for the text display;
said text comprising the word “no” selects a red-like color for the text display;
said text comprising more than five words selects a medium size presentation;
said text having all letter uppercase selects a pop-like animation;
said text comprising an exclamation mark, “!”, selects a drop-like animation; and
said text comprising a question mark, “?”, selects a twirl-like animation.

34. A computer implemented method, comprising the steps of:
providing a messaging client application user interface for a messaging communication involving at least one message recipient and a message sender;
said at least one message recipient receiving a communication that comprises a message to be displayed to said at least one message recipient:
said message being selected by said message sender;,
at least part of the text of said message being supplied by said message sender; and
the graphical animation to be applied to at least part of said message text being selected by said message sender;
wherein said message is presented magnified and comprising said graphical animation of at least part of said message text to said at least one message recipient until an event triggers the dismissal of said presentation.

35. The method of claim 34, said event is any of the following:
a preset timer;
a timer set by said message recipient;
an explicit request of termination from said message recipient;
an implicit request of termination from said message recipient; and
an incoming message.

36. The method of claim 34, said messaging client application user interface resembling any of the following:
an instant messaging client user interface;
an instant messaging client user interface for cellphones;
an instant messaging client user interface for devices having limited screen size capabilities;
an e-mail messaging client user interface;
an e-mail messaging client user interface for cellphones;
an e-mail messaging client user interface for devices having limited screen size capabilities;
a messaging client user interface for cellphones;
a messaging client user interface for devices having limited screen size capabilities;
a SMS-like messaging client user interface for cellphones; and
a SMS-like messaging client user interface for devices having limited screen size capabilities.
